(19) United States
(12) Patent Application Publication
(10) Pub. No.: US 2011/0173094 A1
(43) Pub. Date: Jul. 14, 2011

(54) Electronic Commerce Technique

(76) Inventor: Frederick R. Krueger, Malibu, CA (US)

(21) Appl. No.: 12/781,588

(22) Filed: May 17, 2010

Related U.S. Application Data
(60) Provisional application No. 61/293,492, filed on Jan. 8, 2010.

(51) Int. Cl. G06Q 30/00; G06Q 20/00; G06Q 99/00; G06F 17/30; G06F 3/01

(52) U.S. Cl. 705/26.41; 707/769; 715/760; 707/E17.014

(57) ABSTRACT

Described is a system, method, and product for facilitating a transaction between a buyer and a seller. A buyer searches a data store for an item. The buyer places a bid for the item, the bid including an item name for an item, the item name corresponding to an item identifier, the bid further including a price the buyer wishes to pay for the item. A seller searches the data store for the item. The seller receives a search result identifying the item and the buyer. The seller transmits a notice that the seller wishes to sell the item to the buyer. One or more messages are exchanged via a central server between the buyer and seller to arrange the transaction.

### CROSS-REFERENCE TO RELATED APPLICATION

This application claims the benefit of Provisional Patent Application Ser. No. 61/293,492, filed Jan. 8, 2010, for all purposes including but not limited to the right of priority and benefit of earlier filing date, and expressly incorporates by reference the entire content of Provisional Patent Application Ser. No. 61/293,492.

### BACKGROUND

Traditionally, online marketplace models for goods and services have consisted primarily of items for sale. Generally, each item for sale has been listed for only a short time, perhaps a few weeks. Some buyers are willing to scour such listings in search of a bargain. However, many other buyers wish to purchase items, but do not have the time or patience to search for their desired items. Many such buyers would appreciate the opportunity to present a list of their desired items to sellers, each item at a requested price, thereby offering sellers the opportunity to sell them their desired items at their requested prices.

An adequate technique for presenting buyers' purchase requests to sellers has eluded those skilled in the art, until now.

### SUMMARY

The present invention provides a method for facilitating a transaction between a buyer and a seller, and a system and product for its implementation.

### BRIEF DESCRIPTION OF THE DRAWINGS

FIG. 1 illustrates by way of a block diagram one embodiment of an electronic commerce method, product, and system.

FIG. 2 illustrates one implementation of category table 117 introduced in conjunction with FIG. 1.

FIG. 3 illustrates one implementation of item table 118 introduced in conjunction with FIG. 1.

FIG. 4 illustrates one implementation of user table 119 introduced in conjunction with FIG. 1.

FIG. 5 illustrates one implementation of transaction table 116 introduced in conjunction with FIG. 1.

FIGS. 6 through 18 illustrate representative implementations of web pages 125 introduced in conjunction with FIG. 1.

FIGS. 19 through 22 illustrate representative implementations of messages 127 introduced in conjunction with FIG. 1.

FIGS. 23A and 23B illustrate by way of an operational flow diagram an embodiment of the present invention for an electronic commerce method, product, and system.

FIG. 24 illustrates by way of an operational flow diagram another embodiment of the present invention for electronic commerce method, product, and system.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in commercial environments of any type. Unless explicitly stated, the method embodiments described herein are not constrained to a particular order or sequence. Additionally, some of the described method embodiments or elements thereof can occur or be performed at the same point in time.

The various embodiments described herein are directed to a method, system, and product for facilitating commercial transactions. Briefly stated, the present embodiment allows one or more individuals to indicate to others, via an electronic database, that they wish to purchase and/or sell particular goods or services. A buyer may offer to buy an item at a specified price. (It is contemplated that any buyer may enter into any desired number of such offers, one after another.) Such an offer is referred to herein as a “bid.” Specifically, a “bid” includes at least the name of a desired item and a price the buyer desires to pay for that item. A seller may agree to sell the desired item to the buyer at the price the buyer has specified. Such an agreement is referred to herein as a “hit”, or as “hitting the bid.” In another embodiment, a bid may include a range of prices, and a hit may be an agreement to sell the desired item at a specific price within the range.

As discussed herein, each desired good or service is referred to as an “item”, an individual who wishes to purchase an item is called a “buyer”, and an individual who wishes to sell an item to a buyer is a “seller.” Collectively, buyers and sellers who use the present inventive method, system, and product are called “users”, regardless of whether they have registered to conduct transactions. It is contemplated that in one embodiment, users may search for items and begin the process of bidding (or hitting a bid) before they have registered (or before they have logged in, if they have previously registered), but that all users must either register (if necessary) or login before they may complete the process of bidding or hitting a bid. It is also contemplated that the present invention may facilitate commercial transactions between entities, groups of individuals, or any other parties (real or virtual) that may wish to engage in the buying and/or selling of items.

A transaction service provider may configure a server (the “Server”) to permit users to access, through the Internet or another electronic network or networks, a website which allows each user to search a database of items which may be bought or sold. Alternatively, a user may add one or more items to the database. “Device”, as used herein, means any type of electronic device capable of transmitting and receiving data via the Internet or another electronic network or networks, whether conventional or non-conventional, including but not limited to laptop computers, netbooks, desktop computers, Internet tablets, pagers, PDAs, cellular telephones, and smartphones. “Buyer device” means a device used by a buyer, “seller device” means a device used by a seller, and “admin device” (administrative device) means a device used by an administrator of the present inventive system, method, and product.

One or more data tables may be stored at the Server. The data tables may include, without limitation, a transaction table, a user table, an item table, and a category table. Each user may register to conduct transactions via the Server by using his or her device to transmit new account data to the Server for storage in a user table. “New account data” refers to the data required to register a user to conduct transactions via the Server and may include for each registered user, without limitation, a username, a password, an email address, a city (preferably the city in which the user is located), and a neighborhood within the city.

In one embodiment, even if a user has not registered with the Server, the user may use a device to access the database at the Server to search for a desired item. The user may search for an item's name by entering a query composed of one or more search terms. One or more components at the Server, more fully described below, may search the item table and return a list of search results. Alternatively, the user may search by category (e.g., “smartphones”, in which event one or more components at the Server may search the category table for the appropriate category identifier, then search the item table for items corresponding to that category identifier, and return appropriate search results. If the desired item is not in the database, the user may enter the item's name (e.g., “iphone 3g” or “back massage”), optionally associate that item with a particular category, then cause the data associated with that item to be stored in the item and/or category tables.

If the user locates (or creates) the name of an item in the database which the user would like to purchase, the user may cause one or more components at the Server to create a new transaction record in the transaction table. A “record” as used herein, depending on the context, refers to data stored at data store 115 in connection with a particular item, transaction, category, or user. Each “transaction record”, as used herein, refers to the data associated with one specific desired purchase. After a buyer registers at the Server, the buyer may place a bid for an item by transmitting at least an item name and a desired price to the Server. One or more components at the Server may store the item name and the desired price (i.e., the “bid”) in new transaction record. The new transaction record may include data (referred to herein as a “status”) indicating that the transaction is “open”, meaning that a seller has not yet agreed to sell the item to the buyer at the desired price.

A seller may use his or her device to access the database at the Server and search for items which buyers would like to purchase. When the seller searches for a particular item, for example and without limitation an “iphone 3g”, one or more components at the Server may present a list of one or more buyers (“interested buyers”) who would like to purchase that item. In one embodiment, the seller may click on a link associated with an interested buyer. The seller may then “hit the bid” by indicating that the seller agrees to sell the item at the desired price. One or more components at the Server may cause one or more emails or other messages to be sent to user devices to facilitate the transaction.

By using the current inventive method, system, and product, each buyer and seller who participate in a transaction may be required to agree to terms and conditions. The terms and conditions may require the seller to compensate the transaction service provider when the sale is concluded. Users may be required (or simply allowed) to provide comments and/or ratings regarding other users with whom they have transacted, for display to other users of the present inventive system, method, and product. As used herein, “comment” refers to a remark a first user has made regarding a second user with respect to a transaction conducted between the first user and the second user. “Feedback” means a numerical score a first user has given to a second user with respect to a transaction conducted between the first user and the second user. For example and without limitation, a first user may click on a button which indicates a positive experience the first user had with the second user, which may result in a positive score of “1” being added to the second user's rating. A “rating”, as used herein, means the total numerical score all users have given to a particular user with respect to all transactions conducted with the particular user in connection with the present inventive system, method, and product. For example and without limitation, a first user's rating of “12” may indicate that twelve other users have given positive feedback to the first user. A rating may, without limitation, take the form of the total number of instances on which a seller received positive feedback from buyers. It is contemplated that ratings may be public or private (i.e., private ratings would be viewable only by registered users during authenticated sessions).

All references herein to “link”, “button”, or any other means of conveying instruction via a web page or other electronic means, should be understood to include any element capable of conveying instruction. For example, it should be understood that for any embodiment described herein which refers to the action of “clicking on a button” to indicate the desire to purchase an item, there is an alternative embodiment in which the action of “clicking on a link” is taken to indicate the identical desire. Alternatively, a user may click on an image or take any other conceivable action to provide any necessary or desirable instructions in connection with the present inventive system, method, and product.

It is also contemplated that one or more components at the Server may communicate with one or more financial institutions associated with the buyer and/or seller to provide escrow services in connection with the buyer's payment and/or to arrange for compensation to the transaction service provider from one or more financial accounts associated with the buyer and/or seller.

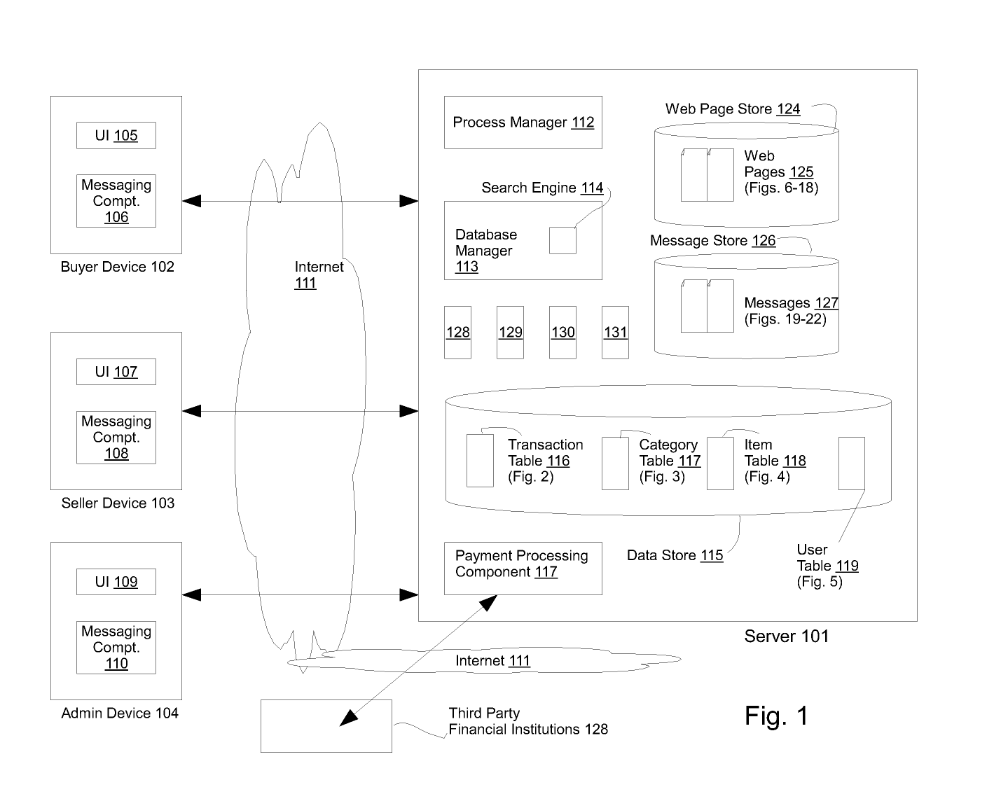

Turning now to FIG. 1, there is illustrated in the form of a block diagram one embodiment of a method, product, and system for facilitating commercial transactions. In the embodiment shown, server 101 (also referred to herein as the “Server”) may be any combination of computer hardware, firmware, and/or software which is capable of storing and executing data. In the embodiment shown in FIG. 1, server 101 is in communication with buyer device 102, seller device 103, and admin device 104. While three user devices are illustrated in FIG. 1 for ease of reference, server 101 may be in communication with any number of user devices. Server 101 may be directly connected to user devices 102, 103, and/or 104. Alternatively, server 101 may be in communication with user devices 102, 103, and/or 104 via the Internet 111 or any other means of remote communication. Any combination of data storage devices, including without limitation computer servers, using any combination of programming languages and operating systems that support network connections, is contemplated for use in the present inventive system, method, and product. The inventive system, method, and product are also contemplated for use with any communication network, and with any method or technology which may be used to communicate with said network, including without limitation wireless fidelity networks, Ethernet, TCP/IP wide-area networks, Universal Serial Bus (USB) cables, and the like. In another embodiment, the features, functions, and operations of server 101 are distributed over two or more items of computing hardware, software, and/or firmware. Admin device 104 may be located at server 101, or alternatively may be server 101.

In the embodiment shown, each user device includes a user interface (“UI”) and a messaging component. Buyer device 102 includes UI 105 and messaging component 106. Seller device 103 includes UI 107 and messaging component 107. Admin device 104 includes UI 109 and messaging component 110. Each UI (105, 107, and/or 109) may take the form of a web browser, or any other means by which text, audio, video, and/or other data may be received and transmitted. Each messaging component (106, 108, and/or 110) may take the form of an email client, or any other means by which messages may be received and transmitted, including without limitation a web browser. In an alternative embodiment, the UI and messaging component on one or more user devices are one single component. For example and without limitation, messages may be received and transmitted via a web browser, which web browser is both the UI and the messaging component for a particular device. In one implementation, “message” means an email. In another implementation, “message” means any text, images, video files, or other data which may be transmitted electronically.

In the embodiment shown, process manager 112 controls all processes which take place at server 101 and which are related to the present inventive system, method, and product. In the embodiment shown, communications component 128 receives data from (and transmits data to) user devices 102, 103, and 104 via the Internet. Process manager 112 is in communication with communications component 128, and receives data via communications component 128. Any reference herein to the transmission of data to, or from, process manager 112 should be understood to include the transfer of data via communications component 128. Further, in this embodiment, any action, process, or step performed by (or directed to) any component other than process manager 112, should be understood to include the transmission from, and receipt of, data by process manager 112 as necessary or desirable in connection with the present inventive method, system, and product. In other embodiments, one or more components at server 101 may communicate directly with user devices without being controlled by process manager 112.

In the embodiment shown, server 101 further includes web server 129. Upon the occurrence of certain events more fully described below, web server 129 retrieves one of web pages 125 from web page store 124 and causes the retrieved web page to be transmitted to a user device, such as buyer device 102. In this embodiment, the user device (such as buyer device 102) displays each web page which is received from web server 129 via a UI (such as UI 105).

In the embodiment shown, server 101 further includes email server 130. Upon the occurrence of certain events more fully described below, a message 127 is transmitted via email server 130 to a user device, such as buyer device 102. In this embodiment, the user device (such as buyer device 102) displays each message which is received from email server 130 via a messaging component (such as messaging component 106). While “messages” refer to emails in this embodiment, it is also contemplated that messages may take the form of any audio, video, text, or other data capable of being transmitting over an electronic network, and that in other embodiments email server 130 may take the form of any component capable of transmitting messages. In another embodiment, one or more messages 127 may be displayed via one or more user interfaces at one or more user devices.

Email server 130 may use any conceivable protocol for the delivery of electronic mail, including without limitation IMAP, POP3, POP, SMTP, SNMP, HTTP, and the like.

In this embodiment, server 101 further includes session manager 131. After a user has registered with server 101 (a process more fully described below), the user may login for an authenticated session. When the user logs in, process manager 112 may cause session manager 131 to initiate an authenticated session, during which session the user has permission to 1) add, remove, or alter data associated with the user's account (i.e., data associated with the user in the user table), 2) place one or more bids; 3) hit one or more bids; or 4) take any other action which is available only to registered users of the present inventive system, method, and product. When the user logs out, process manager 112 may cause session manager 131 to terminate the authenticated session.

In this embodiment, server 101 further includes database manager 113 and search engine 114. Database manager 113 retrieves data from, and stores data in, the data tables at data store 115 as is necessary and/or desirable in connection with the present inventive system, method, and product. In this embodiment, database manager 113 includes search engine 114. When a user transmits a query to server 101, process manager 112 may receive the query and transmit it to search engine 114. “Query” as used herein refers to one or more search terms that a user transmits to search engine 114. Search engine 114 may then search the data tables and provide search results. Process manager 112 may cause the provided search results to be transmitted to the user device from which the query originated.

In the embodiment shown, server 101 includes web page store 124, message store 126, and data store 115. Alternatively, web page store 124, message store 126, and/or data store 115 may be located away from server 101. It is contemplated that server 101 is in communication with web page store 124, message store 126, and data store 115 regardless of whether or not web page store 124, message store 126, and data store 115 are resident on server 101. It is further contemplated that web page store 124, message store 126, and data store 115 may be present on the same data storage medium or media.

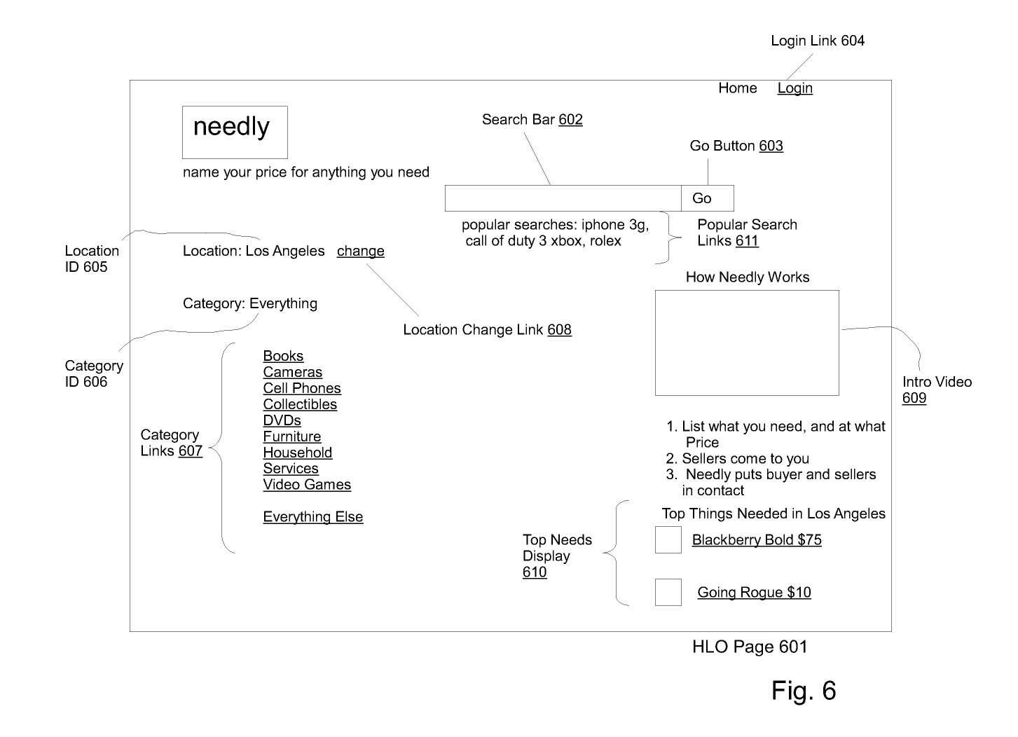

Web page store 124 may comprise, for example and without limitation, volatile and persistent (i.e., non-volatile) media for data storage such as computer-readable instructions or data structures, including but not limited to DVD or other optical storage, RAM, ROM, flash memory, or any other medium which can be used to store information and can be accessed by server 101. Web pages 125 are stored at web page store 124 and are more fully described in FIGS. 6 through 18 below. Each of web pages 125 comprises content, which content may take the form of text, non-textual information, or any other data which may be displayed in a web browser accessible via a user device (such as buyer device 102, seller device 103, and/or admin device 104).

In the embodiment shown upon the occurrence of certain events more fully described below, process manager 112 causes web server 129 to retrieve one of web pages 125 from web page store 124 and causes the retrieved web page to be transmitted to a device, such as buyer device 102.

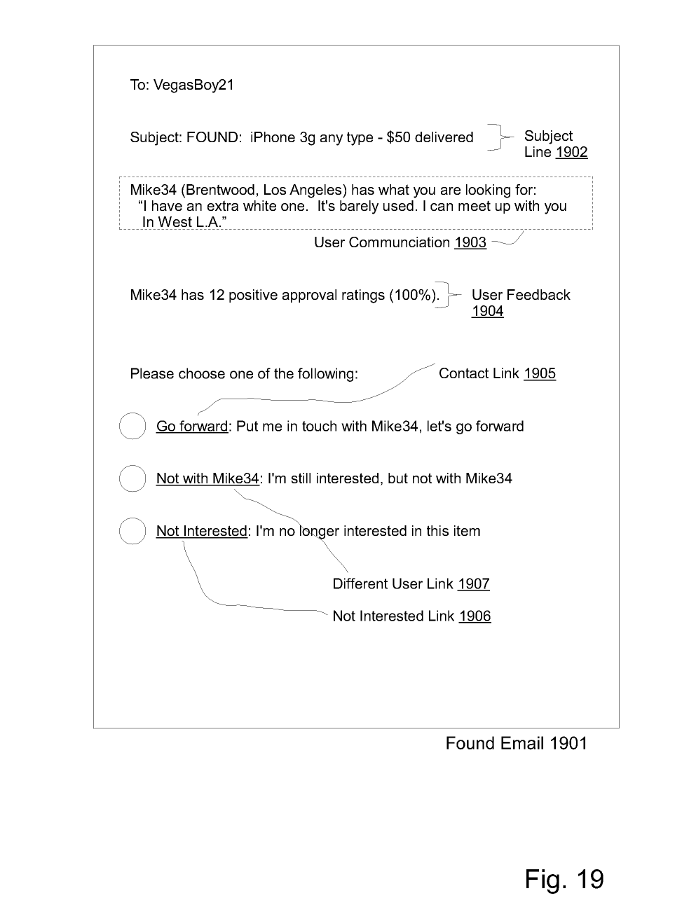

Message store 126 may comprise, for example and without limitation, volatile and persistent (i.e., non-volatile) media for data storage such as computer-readable instructions or data structures, including but not limited to DVD or other optical storage, RAM, ROM, flash memory, or any other medium which can be used to store information and can be accessed by server 101. Messages 127 are stored at message store 126 and are more fully described in FIGS. 19 through 22 below. Each of messages 127 comprises content, which content may take the form of text, non-textual information, or any other data which may be displayed via a messaging component accessible via a user device (such as buyer device 102, seller device 103, and/or admin device 104).

In the embodiment shown, upon the occurrence of certain events more fully described below, process manager 112 generates a message 127 and causes the message 127 to be transmitted to one or more devices via the Internet 111. “Generates” may refer to the creation of a new message 127, the retrieval of a message 127 from data storage, or any other process whereby a message 127 may be produced. It is contemplated that the present embodiment may be used to transmit data, text, video, audio, or any other content capable of being transmitted to a device.

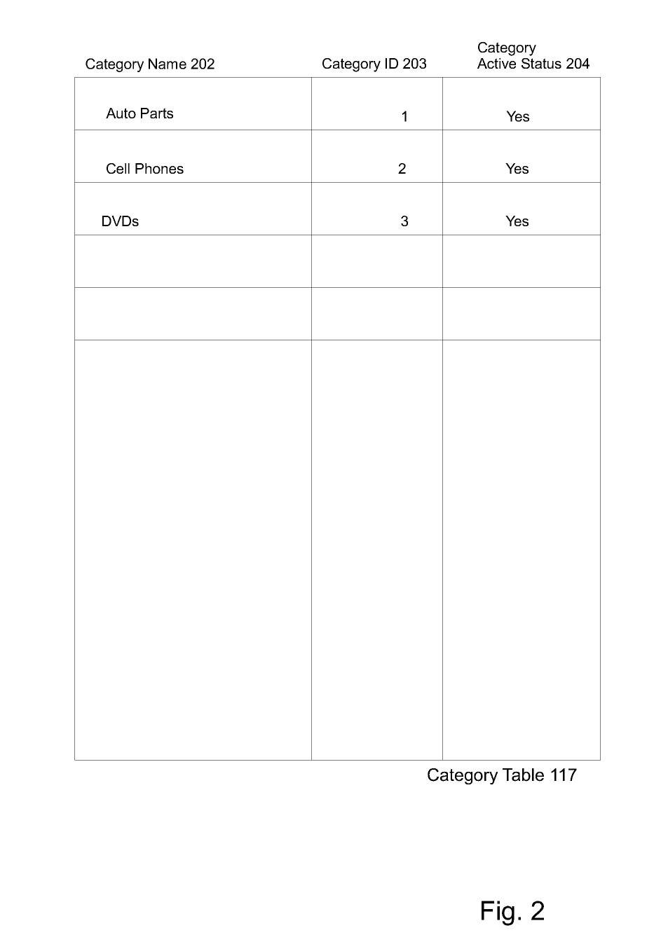

Data store 115 may comprise, for example and without limitation, volatile and persistent (i.e., non-volatile) media for data storage such as computer-readable instructions or data structures, including but not limited to DVD or other optical storage, RAM, ROM, flash memory, or any other medium which can be used to store information and can be accessed by server 101. In the embodiment shown, the following data tables are stored at data store 115: transaction table 116, category table 117, item table 118, and user table 119. These data tables are more fully described in FIGS. 2 through 5 below. As discussed herein, “data tables” and/or “database” refers to the four data tables 116, 117, 118, 119, as well as any other data table which is stored at data store 115 and used in connection with the present inventive method, system, and product. The data tables may be organized within a multidimensional data structure, a relational database, a hierarchical database, or any other conceivable form. Any particular table may include one or more pointers to one or more other tables, one or more data elements within one or more tables, the creation of links between particular data elements, data files, data tables, or particular rows or columns within particular data tables, or any other data or metadata which is necessary or desirable in connection with the present inventive system, method, and product. In short, a description of the data tables contemplated to be used in accordance with the present invention is only limited by one's imagination, and may conceivably be anything or take any form.

It is to be understood that process manager 112 and/or other components described herein may refer to one or more tables as necessary, and may cross-reference the data from one table to another. For example and without limitation, search engine 114 may refer to both category table 117 and item table 118 when determining which items are associated with a particular category.

In the embodiment shown, server 101 further includes payment processing component 117. Payment processing component 117 enables communication with one or more third party financial institutions 128. “Financial institutions” includes without limitation any organization at which a user may have a financial account (such as, without limitation, a checking, savings, or money market account). Without limitation, “financial institutions” includes banks, credit unions, credit card companies, and payment services such as PayPal. It is contemplated that in one or more embodiments, each of one or more users (the “authorizing users”) may authorize a transaction service provider to withdraw and/or deposit funds into one or more financial accounts held by that authorizing user.

Turning now to FIG. 2, there is shown one implementation of category table 117 as introduced in FIG. 1. In the example shown, each row of data within category table 117 is associated with one category name 202—for example and without limitation, “auto parts”. Each category name 202 is associated with a category identifier (“category ID”) 203. Each category ID 203 may be any number or other data capable of designating a particular category name 202. In this embodiment, each category name 202 is also associated with a category active status 204. For each category name 202, that category name 202's category active status 204 indicates whether that category name is “active”, i.e., whether that category should appear in search results. Each category active status 204 may be any number, word, or other data capable of designating that a particular category name 202 is active.

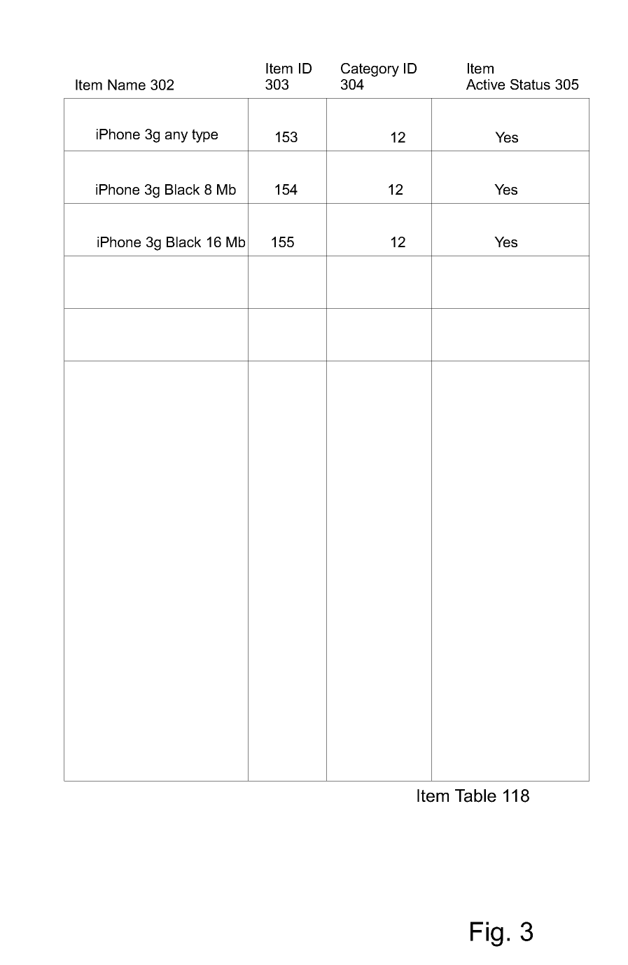

FIG. 3 illustrates one implementation of item table 118 introduced in conjunction with FIG. 1. Each row of data within item table 118 is associated with one item name 302. For example, the top row is associated with “iPhone 3g any type”. Each item name 302 is associated with an item identifier (“item ID”) 303. Each item ID 303 may be any number or other data capable of designating a particular item name 302. In this embodiment, each item name is further associated with a category ID 304. In a preferred embodiment, the category ID 304 provided for each item name 302 in item table 118 matches a category ID 203 provided in category table 117. Upon receiving a query from a user, process manager 112 may cause search engine 114 to refer to item table 118 and/or category table 117 as necessary to produce search results which are relevant to the received query.

In this embodiment, each item name 302 is also associated with an item active status 305. For each item name 302, that item name 302's item active status 305 indicates whether that item name is “active”, i.e., whether that item should appear in search results. Each item active status 305 may be any number, word, or other data capable of designating that a particular item name 302 is active.

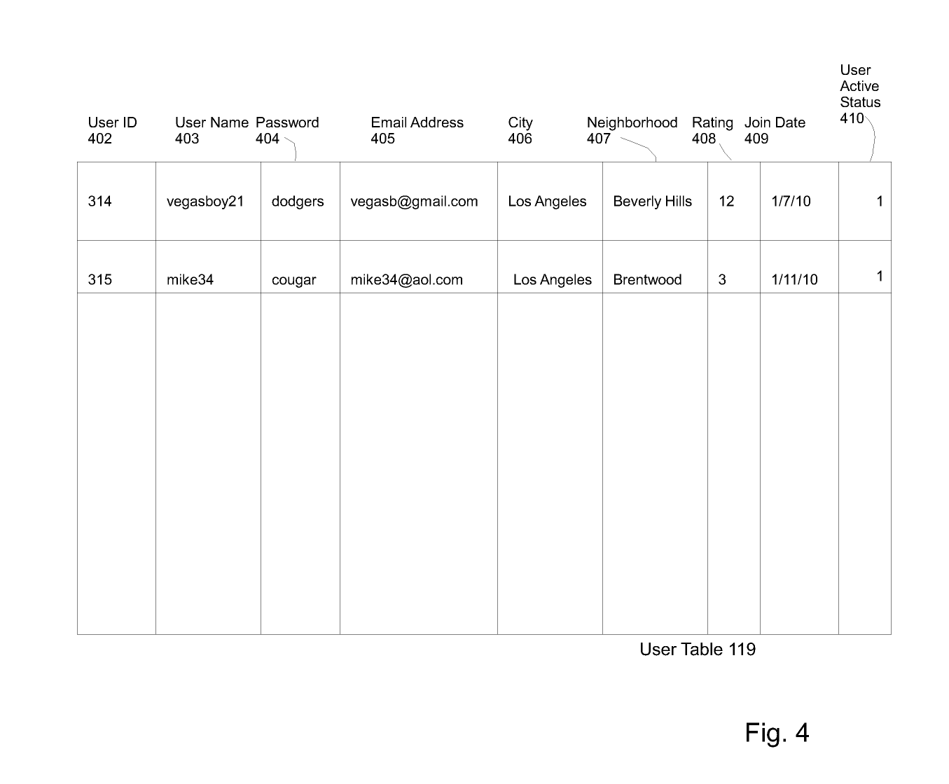

FIG. 4 illustrates one implementation of user table 119 introduced in conjunction with FIG. 1. Each row of data within user table 119 is associated with one user. For example, the top row of the user table 119 illustrated in FIG. 4 contains data relating to a user whose username 403 is “vegasboy21”. Each column within user table 119 contains data of a particular type—for example, the leftmost column of the user data table 119 illustrated in FIG. 4 contains user identifiers (“user ID's”) 402. As illustrated, other columns contain usernames 403, passwords 404, email addresses 405, cities 406, neighborhoods 407, ratings 408, join dates 409, and user active statuses 410. When a user registers with server 101 by transmitting new account data to process manager 112, process manager 112 causes the new account data to be stored within a particular row (which row comprises an “account record” for the user) within user table 119. The new account data for each user may include, without limitation, a username 403, a password 404, an email address 405, a city 406 (preferably the city in which the user is located), and a neighborhood 407 within the city 406 (for example, Brentwood may be a neighborhood associated with Los Angeles).

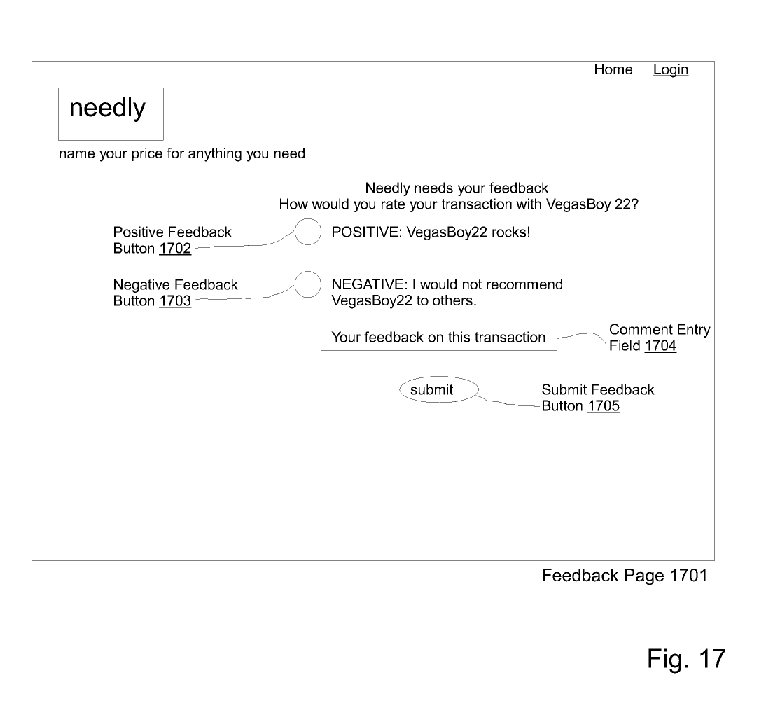

After an account record has been created for the user within user table 119, process manager may cause other data to be added to the user's account record, including without limitation a user identifier (“user ID”) 402 associated with the user, a rating 408 for the user, a join date 409, and a user active status 410. The rating 408 may be determined by the feedback provided by other users via feedback page 1701 (described more fully in FIG. 17 below). For example, rating 408 may indicate the number of other users who have indicated that they had a positive experience performing a transaction with the user.

It is contemplated that, when a user's rating reaches one or more specific levels, one or more stars or other graphics may appear next to the user's rating whenever the user's rating is displayed in connection with the present inventive system, method, and product. For example and without limitation, a blue star may appear next to a user's rating when the user's rating changes from “4” to “5”, and a gold star may appear next to the user's rating when the user's rating changes from “9” to “10”.

Join date 409 may be the date the user created an account record by transmitting new account information to process manager 112. User active status 410 may indicate whether the user currently has permission to engage in transactions via the present inventive method, system, and product. For example and without limitation, a user active status of “1” may indicate the user currently has permission and is not banned from engaging in transactions. A user active status of “2” may indicate the user is banned and may not engage in transactions. It is contemplated that user table 119 may contain any and all other data which is necessary or desirable to facilitate the operation of the present embodiment. For any given user, such other data may include, but is not limited to, the user's actual name (e.g., “Bill Smith”), account numbers and other data associated with one or more financial accounts the user has with one or more financial institutions; and a mailing address associated with the user. It is contemplated that payment processing component 117 may access user financial data stored at user table 119 in connection with the present inventive system, method, and product with respect to any necessary or desirable transactions with third party financial institutions, including without limitation one or more exchanges of funds.

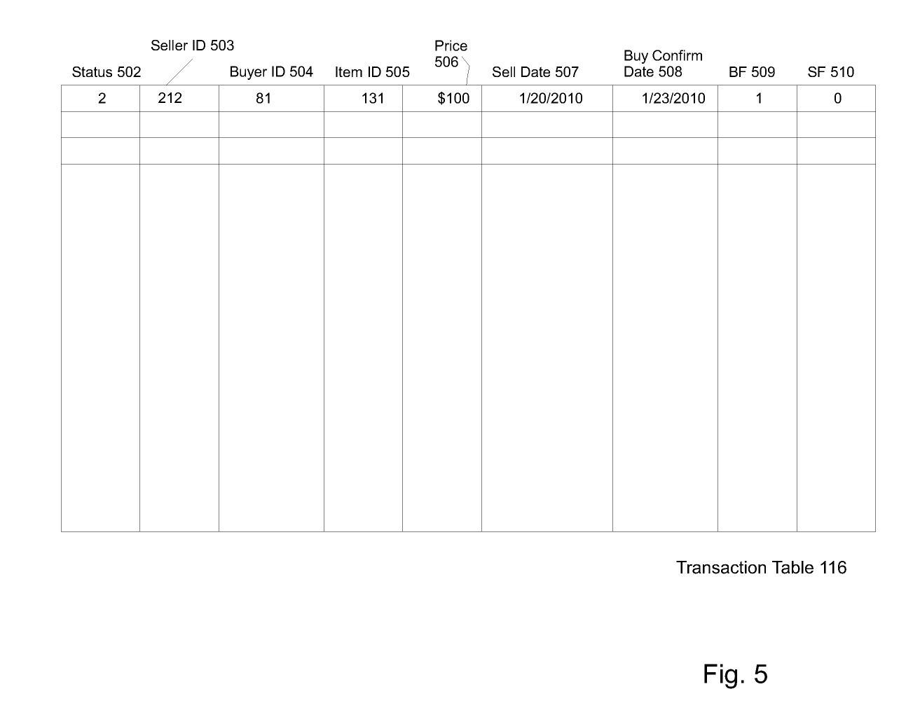

FIG. 5 illustrates one implementation of transaction table 116 introduced in conjunction with FIG. 1. Each row of data within transaction table 116 comprises one transaction record. When a buyer places a bid, which is more fully described below, process manager 112 causes the user ID 402 associated with the buyer to be stored in buyer ID 504 of a new transaction record at transaction table 116. The item ID 303 associated with the buyer's desired item is stored in item ID 505 of the new transaction record at transaction table 116. The buyer's desired price is stored in price 506 of the new transaction record at transaction table 116. In this embodiment, process manager 112 causes a status indicator to be stored in status 502 of the new transaction record at transaction table 116. For any given transaction record, status 502 may indicate the transaction status—for example and without limitation, a status of “0” may indicate the transaction is open, “1” may indicate a seller has agreed to sell the desired item to the buyer, “2” may indicate the buyer has confirmed his or her agreement to purchase the item from the buyer at the designated price, “3” may indicate the transaction is “closed” (i.e., that the seller has received payment from the buyer), and “4” may indicate that the transaction has been abandoned (i.e., that the buyer has retracted his or her offer to purchase the previously desired item). These status indicators are merely representative; the status indicators in status 502 may refer to any type of status and may take any form.

When a seller hits a buyer's bid, process manager 112 may cause the user ID 402 associated with the seller to be stored in seller ID 503 of the relevant transaction record. Each transaction record may, without limitation, further include a sell date 507 on which the seller agreed to supply the desired item for the designated price. Each transaction record may also include a buy confirm date 508, on which the buyer confirmed his or her agreement to purchase the item from the buyer at the designated price. There may also be provided, for any given transaction record, buyer feedback (“BF”) 509 and/or seller feedback (“SF”) 510. BF 509 may indicate the seller's opinion concerning the buyer—for example and without limitation, “0” may indicate no feedback regarding the buyer, “1” may indicate the buyer is viewed positively, and “2” may indicate the buyer is viewed negatively. SF 510 may indicate the buyer's opinion concerning the seller—for example and without limitation, “0” may indicate no feedback regarding the seller, “1” may indicate the seller is viewed positively, and “2” may indicate the seller is viewed negatively.

FIGS. 6 through 18 illustrate representative implementations of web pages 125 introduced in conjunction with FIG. 1. It is to be understood that one or more web pages 125 may permit an individual to enter content, click on a link, or perform one or more other actions which cause the individual's device (i.e., one of the following depending on context: buyer device 102, seller device 103, and/or admin device 104) to communicate with one or more components on server 101.

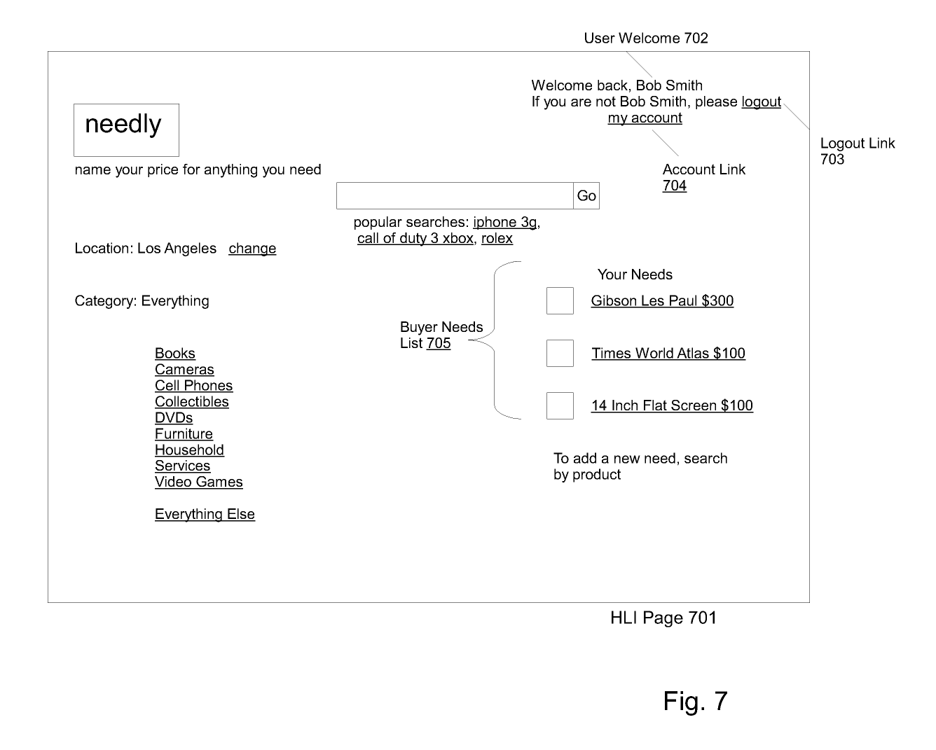

FIG. 6 illustrates one embodiment of home logged out page (“HLO page”) 601, which may be accessed by a user, for example and without limitation the user of buyer device 102, who activates UI 105 at buyer device 102 and accesses HLO page 601 at a website available at a URL such as <www.needly.com>. The user may click on login link 604, whereupon process manager 112 causes a login page to be displayed, which login page provides the user with an opportunity to enter his or her username 403 and password 404. After the user enters his or her username 403 and the password 404 which is associated with that username 403 in user table 119, process manager 112 causes a home logged in page (“HLI page”) to be displayed at UI 105 at buyer device 102. The HLI page is more fully described in FIG. 7 below. An identical login procedure may be followed by a seller who is using seller device 103 and accessing HLO page 601 via UI 107.

The term “link” as used herein may include without limitation a hyperlink URL which, when clicked on, causes process manager 112 to instruct web server 129 to retrieve a specific web page 125 from web store 124, and further causes the specific web page 125 to be transmitted to the user interface of the device associated with the user who clicked on the link.

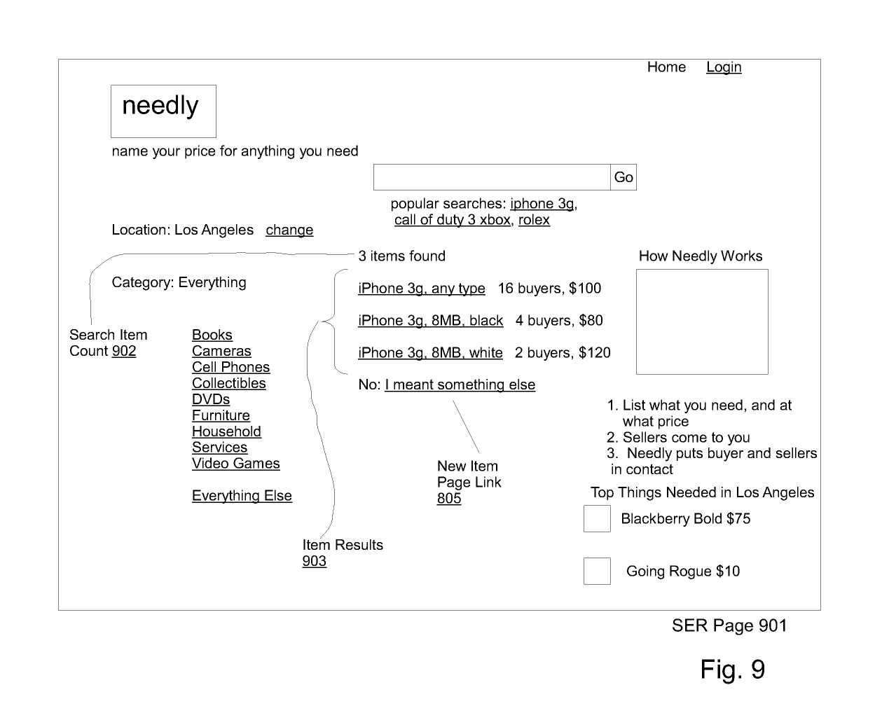

The use of login link 604 is optional. In the event the user does not click on login link 604, the user may nevertheless use any of the other functionalities provided via HLO page 601. Search bar 602 allows the user to enter a query, i.e., one or more search terms associated with an item. The item may be an item that a buyer wishes to buy, or an item that a seller wishes to sell. After one or more search terms are entered into search bar 602, the user may click on go button 603. This causes the query to be transmitted to search engine 114 via process manager 112. Alternatively, the user may click on one of popular search links 611 provided at HLO page 601. A “popular search link” as used herein means a predefined query (for example and without limitation, “iphone 3g”) that is presented to a user via a web page and that, when clicked on, results in the transmission of the predefined query to search engine 114. The resulting processes are described in connection with FIG. 9 below (which illustrates one embodiment of search page 901).

It is contemplated that search engine 114, process manager 112, and/or any other components of the present inventive system, method, and product may cause data pertaining to one or more queries, which queries are directed to search engine 114, to be stored at data store 115 for any conceivable purpose, including without limitation the presentation of search results directed to one or more particular locations (such as cities and/or neighborhoods), to one or more particular demographic groups, and the like. For example, process manager 112 may cause search engine 114 to keep track of the most popular searches conducted by users in various locations, and may present popular search links 611 that are location-specific, i.e., process manager 112 may generate popular search links 611 which correspond to the most frequently used queries in a user's city (or neighborhood).

HLO page 601 may also provide a location identifier (“location ID”) 605, which either indicates the user's location or provides a default location (in this example, Los Angeles). After the user undertakes the login procedure described above, process manager 112 may obtain the user's city 406 and/or neighborhood 407 from the account record in user table 119 which is associated with the user. Process manager 112 may then cause the city 406 and/or neighborhood 407 to be displayed as location ID 605 at HLO page 601. In the embodiment shown, there is provided a location change link 608. When the user clicks on location change link 608, process manager 112 may causes a change location page to be displayed, which change location page provides the user with an opportunity to choose a different location ID 605 than was originally provided at HLO page 601. After the user enters a new location ID 605, process manager 112 may cause the new location ID 605 to be displayed at HLO page 601.

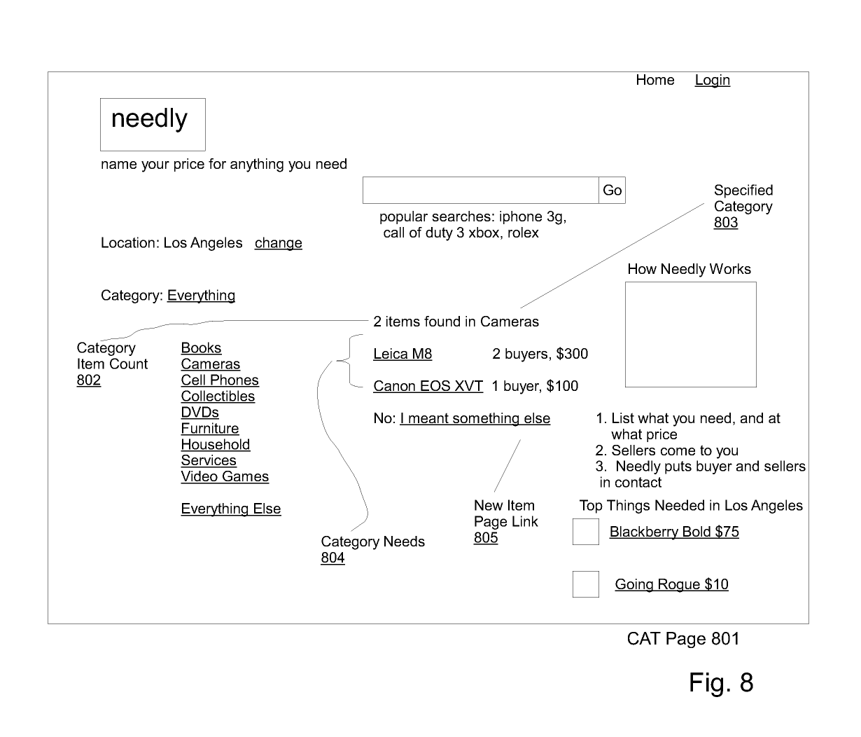

In the embodiment shown, there is also provided a category ID 606. Category ID 606 indicates the category name 202 from category table 117 that contains item names in which the user is interested. By default, category ID 606 may be “everything”. This means that a query within search bar 602 will result in a search for item names associated with all category names, not just one selected category name. Alternatively, the user may click on one of the links provided within category links 607, each of which is associated with a particular category name 202 within category table 117. For example, if the user clicks on “cell phones” within category links 607, this may cause the retrieval and display of search results which are associated only with item names that are associated with the category name 202 “cell phones” (i.e., item names 302 whose category ID's 304 correspond to the category ID 203 which is associated with the selected category name 202). The resulting process is described in connection with FIG. 8 below (which illustrates one embodiment of category results page 801).

HLO page 601 may also provide an introductory video 609 (“intro video 609”). Intro video 609 may explain the present inventive system, method, and/or product for facilitating electronic commerce. Intro video 609 may in the form of a Flash, MPEG, .MOV or any other type of video file, and may be retrieved and displayed at HLO page 601 when the user clicks on an arrow or other symbol located within (or near) a rectangle or other area associated with intro video 609.

HLO page 601 may further provide a top needs display 610. Top needs display 610 may be a list of the item names within item table 118 for which users within a default city (e.g., Los Angeles) or, alternatively, the user's city 406 (and/or neighborhood 407) have the greatest need. Process manager 112 may search transaction table 116 to determine which transactions remain open (for example and without limitation, which transactions have a status 502 of “0”, indicating that the buyer has not yet found a seller). Process manager 112 may then determine which item ID's 505 appear in the greatest numbers within the open transactions (such item ID's are referred to herein as the “greatest needs”), and may search item table 118 to retrieve the item names 302 which are associated with the greatest needs. Process manager 112 may cause the item names 302 which are associated with the greatest needs to be displayed via top needs display 610 at HLO page 601.

FIG. 7 illustrates one embodiment of home logged in page (“HLI page”) 701. Process manager 112 may cause HLI page 701 to be displayed by the relevant UI, for example UI 105 associated with buyer device 102, after the user undertakes the login procedure described above in connection with FIG. 6. HLI page 701 may be substantially similar to HLO page 601. In the embodiment shown, HLI page 701 includes a user welcome 702, which may provide a greeting directed to the username 403 which is associated, in user table 119, with the user who has undertaken the login procedure. Alternatively, the greeting may be directed to the user's actual name, or any other identifying information included within the user's account record at user table 119.

HLI page 701 also provides logout link 703. By clicking on logout link 703, the user may cause process manager 112, via session manager 131, to terminate the session which was initiated by the login process described above in connection with FIG. 6. Subsequently, any web pages 125 displayed while the user is using the current inventive system, method, and product will not reflect any data from the user's account record stored at user table 119, until the user once again completes the login process. HLI page 701 further provides an account link 704. When the user clicks on account link 704, process manager 112 may cause an account page to be displayed, which account page provides the user with an opportunity to alter data associated with his or her account record stored at user table 119. After the user makes any desired changes to this data, process manager 112 may cause the revised data to be stored within the user's account record at user table 119.

In this embodiment, HLI page 701 further provides a buyer needs list 705. Buyer needs list 705 includes one or more open transactions associated with the user. After the user logs in, process manager searches transaction table 116 and user table 119 to retrieve the open transactions associated with the buyer, i.e., the transactions with an open status 502 (for example, status 502=“0”) and a buyer ID 504 which matches the user's user ID 402. Consequently, process manager 112 searches item table 118 to retrieve the item names 302 that are associated with the item ID's 505 which correspond to the open transactions associated with the user. Process manager 112 causes the retrieved item names 302 to be displayed in buyer needs list 705 at HLI page 701.

FIG. 8 illustrates one embodiment of category results page (“CAT page”) 801. When a user clicks on one of the category links 607 which may be provided on a web page 125 (for example, on HLO page 601), process manager 112 may search item table 118 to retrieve the item names 302 which are associated with the particular category ID 203, which particular category ID 203 is associated with the link on which the user has clicked. (All such item names are referred to herein as the “subset item names”). Process manager 112 may search transaction table 116 to determine which open transactions are associated with the subset item names. (All such transactions are referred to herein as the “applicable transactions”.) Process manager 112 may refer to item table 118, and may cause one or more of the item names 302 which are associated with one or more item ID's 505 within one or more applicable transactions (collectively, such item names are the “relevant item names”), to be displayed in category needs 804 on CAT page 801. For each relevant item name, process manager 112 may also determine the number of different buyer ID's 504 which are associated with the applicable transactions for that relevant item name (the “buyer number” for that relevant item name). Process manager 112 may cause the buyer number to be displayed within category needs 804 for each relevant item name. For each relevant item name, process manager 112 may also cause the highest price 506 (or the lowest price 506, or the average price 506) associated with that relevant item name to be displayed within category needs 804.

Each category need 804 may be associated with a link to a particular implementation of item detail page 1001, which is more fully described below.

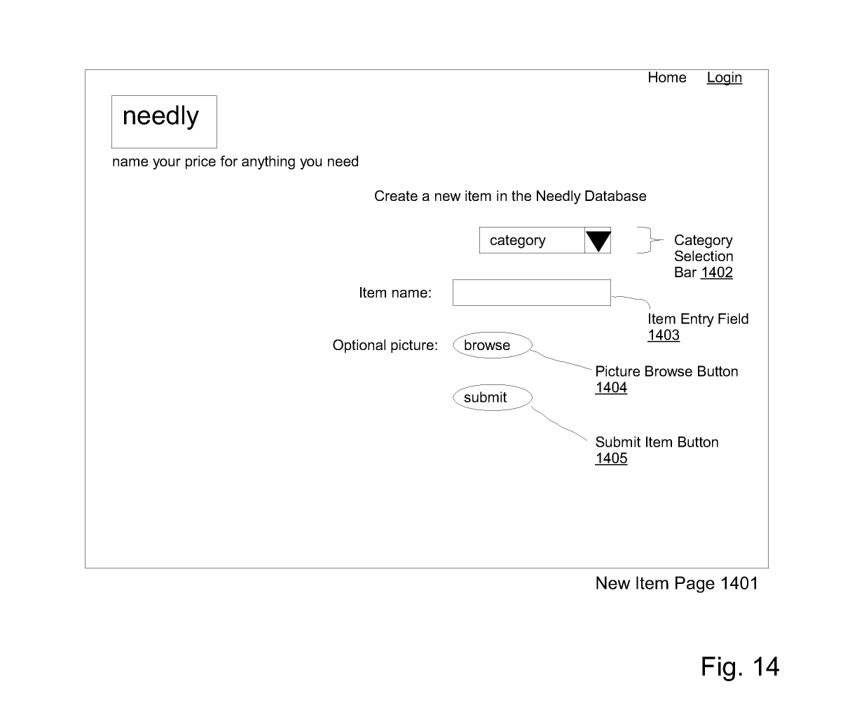

CAT page 801 may also display category item count 802, which is the number of relevant item names. CAT page 801 may display specified category 803, which is the category name 202 associated with the category link 607 on which the user has previously clicked. Category ID 606 may also change in response to the user's selection of a category link 607. CAT page 801 may also provide a new item page link 805. When a user clicks on new item page link 805, process manager 112 may cause the applicable user interface (for example, UI 105 at buyer device 102) to display new item page 1401, which is described in FIG. 14 below.

FIG. 9 illustrates one embodiment of search page (“SER page”) 901. After a user enters one or more search terms into search bar 602 and clicks go button 603, the query may be transmitted to search engine 114 via process manager 112. Search engine 114 may then cause database manager 113 to search item table 118. Database manager 113 may locate all item names 302 which contain one or more search terms associated with the query (all such names are referred to herein as the “subset of item names”). Database manager 113 may determine which item names 302 within the subset of item names are active (the “active item names”), by referencing the item active status 305 for each item record associated with the subset of item names. Database manager 113 may determine which active item names are associated with open transactions by referring to transaction table 116 (all such active item names are referred to herein as the “item results”). Process manager 112 may cause the item results to be displayed in item results 903 on SER page 901. For each item result, process manager 112 may also determine the number of different buyer ID's 504 which are associated with the applicable transactions for that item result (the “buyer number” for that item result). Process manager 112 may cause the buyer number to be displayed within item results 903 for each item result. For each item result, process manager 112 may also cause the highest price 506 associated with that item result to be displayed within item results 903.

Alternatively, if a user has clicked on one of popular search links 611 provided at HLO page 601, a predefined query may be transmitted to search engine 114 via process manager 112. For example, clicking on the popular search link “iphone 3g” may cause the query “iphone 3g” to be transmitted to search engine 114 via process manager 112. In this case, the remainder of the process may continue as outlined in the preceding paragraph.

Each item result 903 may be associated with a link to a particular implementation of item detail page 1001, which is more fully described below.

SER page 901 may also display search item count 802, which is the number of item results. SER page 901 may also provide a new item page link 805. When a user clicks on new item page link 805, process manager 112 may cause the applicable user interface (for example, UI 105 at buyer device 102) to display new item page 1401, which is described in FIG. 14 below. Process manager 112 may also cause new item page 1401 to be displayed if the user's query returns no item results. SER page 901 may allow a user to select a category, in which event a query entered into search bar 602 may return only those item results which are associated with the selected category.

The term “search results”, as used herein, includes category needs 804, item results 903, and any other data which search engine 114 may provide to a user in response to a query. It is contemplated that any web page used in connection with the present inventive system, method, and product may provide (without limitation) any of the following data in connection with search results: one or more user comments, specific details regarding one or more buyers' purchase requests, offers from sellers (each offer including at least the name of an item for sale and a desired price for that item), specific details regarding one or more offers made by sellers, one or more counteroffers from sellers (including without limitation offers to sell an item at a price higher than a buyer's desired price), feedback, one or more ratings, or any other data which may be contemplated to be presented in connection with the present inventive system, method, and product. It is to be understood that the present inventive system, method, and product may be used in connection with seller offers to buyers, and that each seller offer may have an associated transaction record at transaction table 116. It is contemplated that, in one embodiment, one or more seller offers made through the present inventive method, system, and product may be offered in connection with one or more “liquidation prices” for the items being sold, i.e., discounted prices set at a level designed to attract immediate acceptance of the terms of sale.

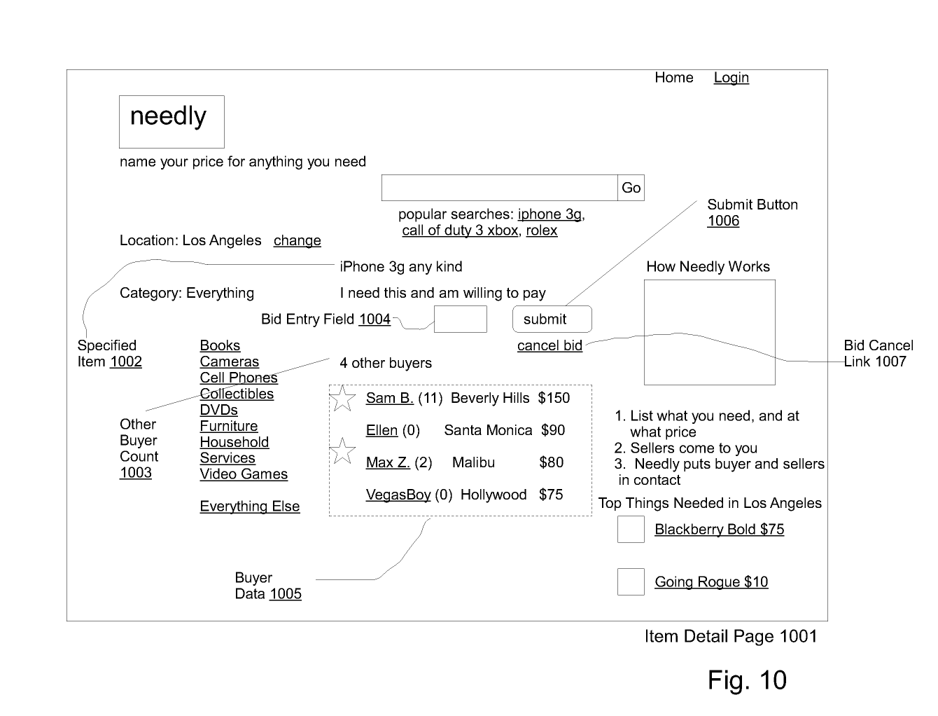

FIG. 10 illustrates one embodiment of item detail page (“ITM page”) 1001. When a user clicks on a category need 804 via CAT page 801—or, alternatively, when a user clicks on an item result 903 via SER page 901—process manager 112 causes the relevant user interface (for example, UI 105 at buyer device 102) to display an implementation of ITM page 1001, which implementation is related to the category need 804 (or, alternatively, the item result 903) on which the user has clicked. In the embodiment shown in FIG. 10, the user has clicked on a category need 804 (or a item result 903) for “iphone 3g any kind”. Specified item 1002 may indicate the relevant item name related to the category need 804 on which the user has previously clicked. Alternatively, specified item 1002 may indicate the item result related to the item result 903 on which the user has previously clicked.

ITM page 1001 may also display other buyer count 1003, which is the number of buyers (aside from the user) (all such buyers are referred to herein as “other buyers”) who have created an open transaction for the specified item 1002. Process manager 112 may determine the number of other buyers by referring to one or more data tables at data store 115.

ITM page 1001 may further display buyer data 1005. Buyer data 1005 may include, without limitation, the username, rating, and city associated with each of the other buyers (or a subset of one or more other buyers selected by process manager 112), as well as (for each other buyer) the price 506 associated with the other buyer's open transaction for the specified item 1002. Process manager 112 may cause database manager 113 to retrieve the buyer data 1005 by referring to one or more data tables at data store 115. Process manager 112 may cause the buyer data 1005 to be displayed via I™ page 1001. For each other buyer listed within buyer data 1005, there may be provided a link to a user page 1101 associated with that other buyer. The user page 1101 is more fully described below.

If a user wishes to acquire the specified item, the user may enter a desired price for the item via bid entry field 1004, then click on submit button 1006, which may cause process manager 112 to create a new open transaction in transaction table 116. The open transaction created thereby in transaction table 116 may include, without limitation, the buyer ID 504 associated with the user, the item ID 505 associated with the specified item, and the price 506 which the user has entered via bid entry field 1004. ITM page 1001 may also include cancel bid link 1007, which may allow the user to cancel his or her bid for the specified item 1002.

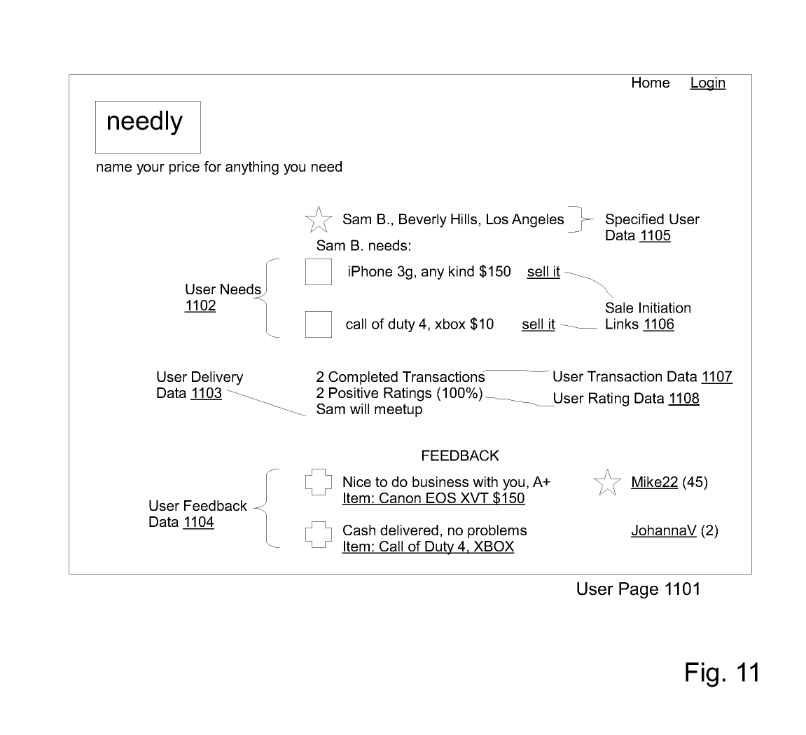

FIG. 11 illustrates one embodiment of user page 1101. When a user (for example, a seller using seller device 103) clicks on a link associated with a particular other buyer within buyer data 1005 at ITM page 1001 (the “selected buyer”), process manager 112 causes the relevant UI (for example, UI 107 at seller device 103) to display an implementation of user page 1101 related to the selected buyer. In the embodiment shown, user page 1101 includes specified user data 1105 pertaining to the selected buyer. Process manager 112 may cause database manager 113 to retrieve the specified user data 1105 by referring to one or more data tables at data store 115. Process manager 112 may cause the specified user data 1105 to be displayed via user page 1101.

In this embodiment, user page 1101 further includes user needs 1102, which in this embodiment is a list of one or more item names 302. Each of the one or more item names 302 corresponds to an item ID 505 associated with an open transaction related to the selected buyer. In this embodiment, user needs 1102 further includes the price 506 associated with each displayed item name (i.e., each item name displays the price the selected buyer is willing to pay for the associated item).

As illustrated, user page 1101 further includes user transaction data 1107, which indicates the number of transactions the selected buyer has completed. User rating data 1108 indicates the number of positive ratings the selected buyer has received, as indicated by the rating 408 in the selected buyer's account record stored at user table 119. User rating data 1108 may also include the percentage of all transactions in which the selected buyer has engaged, for which the selected buyer has received positive ratings. User delivery data 1103 indicates the conditions under which the selected buyer prefers to receive delivery of the items for which the selected buyer has placed bids. User delivery data 1103 may be stored at user table 119 or, alternatively, at any other database which may be used in connection with the present inventive method, system, and product.

As illustrated, user page 1101 further includes user feedback data 1104. Without limitation, user feedback data 1104 may include one or more names of other individuals with whom the selected buyer has engaged in transactions (such individuals are referred to herein as “associated users”), the comments the associated users have made about the selected buyer, the item names associated with the transactions in which the selected buyer has engaged with the associated users, and/or the ratings of the associated users. User feedback data 1104 may be stored at user table 119 or, alternatively, at any other database which may be used in connection with the present inventive method, system, and product.

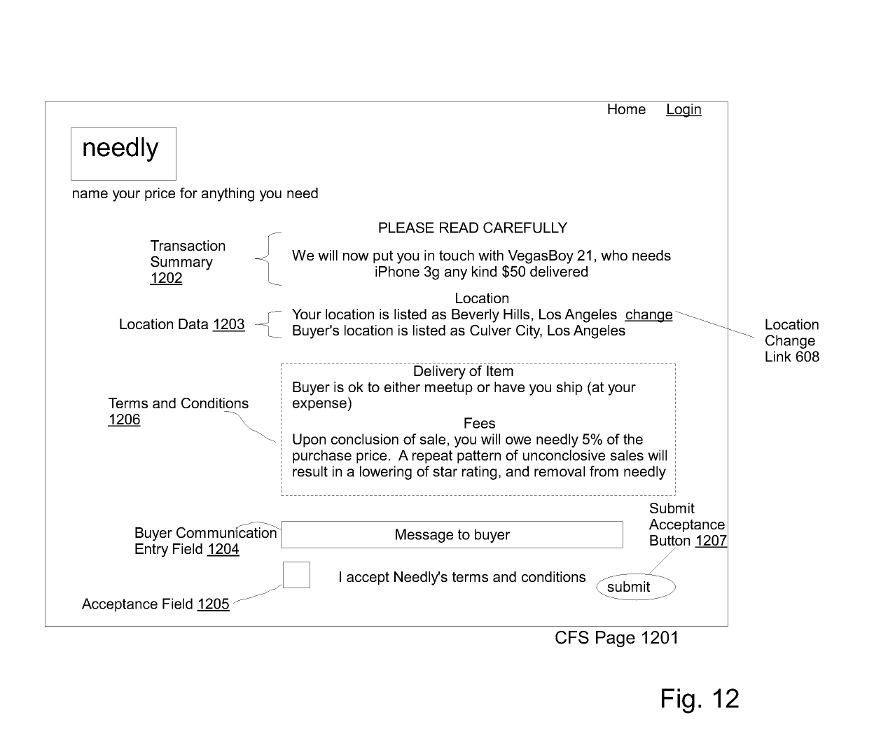

As illustrated, a sale initiation link 1106 is provided in connection with each user need 1102. If a user wishes to sell the item associated with a particular user need (the user who wishes to sell is referred to herein as “the seller”), the seller may click on the sale initiation link associated with the relevant user need 1102. (Such action is referred to herein as a “notice” that the seller wishes to sell the item associated with the sale initiation link.) When the seller clicks on the sale initiation link 1106, process manager 112 may cause a particular implementation of confirm sale page 1201 to be displayed. Alternatively, process manager 112 may omit the confirmation process outlined below with respect to FIG. 12, and may add the seller ID 503 associated with the seller to the open transaction within transaction table 116, which open transaction is associated with the particular user need (the “relevant transaction”). In that event, process manager 112 may also add the sell date 507 to the relevant transaction, and may change the status 502 of the relevant transaction from “open” (e.g., “0”) to “seller found” (e.g., “1”).

FIG. 12 illustrates one embodiment of confirm sale page (“CFS page”) 1201. An implementation of CFS page 1201 may be transmitted to UI 107 at seller device 103 when the seller clicks on a sale initiation link 1106 on user page 1101. As illustrated, CFS page 1201 includes a transaction summary 1202, which may include the username 403 associated with the selected buyer, as well as the item name 302 and the price 506 associated with the user need 1102 for which the seller clicked a sale initiation link 1106. CFS page 1201 further includes location data 1203, which in this embodiment includes the cities 406 and neighborhoods 407 associated with the seller and the selected buyer. In this embodiment, there is provided a location change link 608. Clicking on the location change link 608 allows the seller to change the location data associated with the seller.

In this embodiment, CFS page 1201 includes terms and conditions 1206. In this embodiment, the seller is required to accept terms and conditions 1206 before the seller may enter into a transaction with the selected buyer. There is provided a buyer communication entry field 1204, into which the seller may enter text or other content which the seller would like to have delivered to the selected buyer's messaging component 106 at buyer device 102. There is also provided acceptance field 1205. The seller may click on acceptance field 1205 and click submit acceptance button 1207. After the seller performs both actions—clicking on acceptance field 1205 and clicking submit acceptance button 1207—process manager 112 adds the seller ID 503 associated with the seller to the relevant transaction. Process manager 112 may also add the sell date 507 to the relevant transaction, and may change the status 502 of the relevant transaction from “open” (e.g., “0”) to “seller found” (e.g., “1”). Process manager 112 may cause UI 107 at seller device 103 to display a web page 125 which indicates the seller has confirmed the sale; alternatively, process manager 112 may cause a message 127 to be transmitted to messaging component 108 at seller device 103, which message 127 indicates the seller has confirmed the sale. If the seller has entered content into buyer communication entry field 1204, process manager 112 may generate a message 127 which includes the desired content and cause a found email 1901 (more fully described below) which contains the desired content to be transmitted to messaging component 106 at buyer device 102.

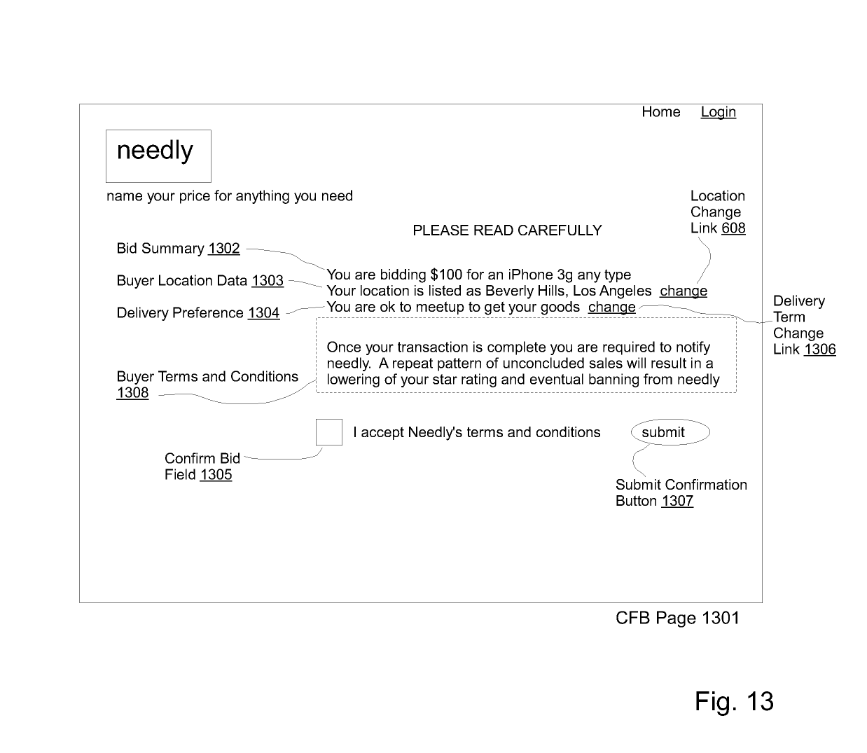

FIG. 13 illustrates one embodiment of confirm bid page (“CFB page”) 1301. Process manager 112 may cause CFB page 1301 to be displayed by a user interface at a user device, such as UI 105, when a user enters a desired price for an item via bid entry field 1004, then clicks on submit button 1006 at ITM page 1001. If the user has not initiated an authenticated session, process manager 112 may cause a login page to be displayed at the user interface of the user's device, and may require the user to login before causing CFB page 1301 to be displayed. Alternatively, if the user has not initiated an authenticated session, process manager 112 may cause create account page 1501 to be displayed at the user interface of the user's device, and may require the user to create a new account, before causing CFB page 1301 to be displayed. Alternatively, if the user has not initiated an authenticated session, process manager 112 may cause a web page to be displayed which presents the option to either login or create a new account.

As illustrated, CFB page 1301 includes a bid summary 1302, which may include the item name 302 and the price 506 associated with the item for which the user has placed a bid. CFB page 1301 further includes buyer location data 1303, which in this embodiment includes the city 406 and neighborhood 407 associated with the user who has placed a bid (i.e., the buyer). In this embodiment, there is provided a location change link 608. Clicking on the location change link 608 allows the buyer to change the location data associated with the buyer.

In this embodiment, CFB page 1301 further includes delivery preference 1304, which indicates the conditions under which the buyer prefers to receive delivery of the item for which the buyer has placed a bid. Delivery preference 1304 may be stored at the buyer's account record at user table 119 or, alternatively, at any other database which may be used in connection with the present inventive method, system, and product. In this embodiment, there is provided a delivery term change link 1306. Clicking on the delivery term change link 1306 allows the buyer to change the delivery preference associated with the buyer.

In this embodiment, CFB page 1308 includes buyer terms and conditions 1308. In this embodiment, the seller is required to accept buyer terms and conditions 1308 before the buyer may create an open transaction. There is provided a confirm bid field 1305. The buyer may click on confirm bid field 1305 and click submit confirmation button 1307. After the buyer performs both actions—clicking on confirm bid field 1305 and clicking submit confirmation button 1307—process manager 112 creates an open transaction for the user's bid. Process manager 112 may then cause HLI page 701 to be displayed via UI 105 at buyer device 102.

FIG. 14 illustrates one embodiment of new item page (“NIT page”) 1401. Process manager 112 may cause NIT page 1401 to be displayed by a user interface at a user device, such as UI 105, when the user's query fails to produce any relevant search results (or category needs). For example and without limitation, NIT page 1401 may be displayed at UI 105 after a buyer searches for “iphone 3g” in search bar 602 and search engine 114 determines there are no instances of “iphone 3g” in item names 302 within item table 118. NIT page 1401 provides an item entry field 1403 which permits the user to enter a description of his or her desired item. As illustrated, NIT page 1401 also includes a category selection bar 1402, which permits the user to select an appropriate category from a drop-down menu. The user may optionally include an image file, which may be selected from the available options when the user clicks on picture browse button 1404. When the user clicks on submit item button 1405, process manager 112 causes a new row to be created in item table 118. The user's item description is stored in the new row as item name 302, an item ID 303 is assigned to the new item, the category ID 304 is assigned in accordance with the user's designated category, and item active status 305 is set to indicate the new item is active. If the user has included an image for the item, that image may be stored in any conceivable manner at data store 115. Such item images may be displayed alongside category needs 804 at CAT page 801. Such item images may also be displayed alongside item results 903 at SER page 901. After the user has caused process manager 112 to add the new item to the database, process manager 112 may cause an embodiment of ITM page 1001 to be displayed at the user's device via a UI, thereby permitting the user to place a bid on the item associated with the newly created row in item table 118.

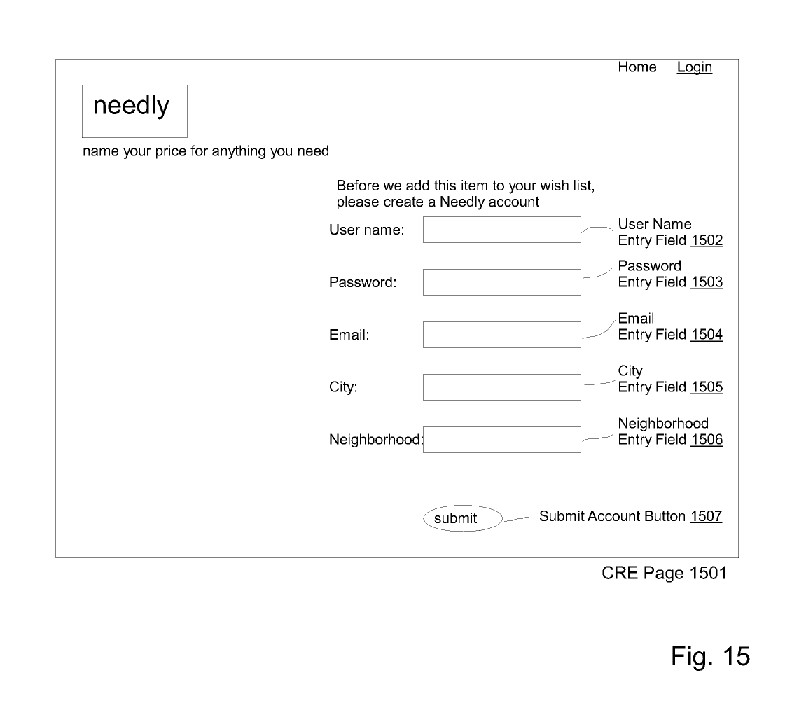

FIG. 15 illustrates one embodiment of new account creation page (“CRE page”) 1501. CRE page 1501, as illustrated, includes a user name entry field 1502, into which a user may enter a username to be stored in his or her newly created account record in user table 119, as username 403. CRE page 1501 further includes a password entry field 1503, into which a user may enter a password to be stored in his or her newly created account record in user table 119, as password 404. CRE page 1501 further includes an email entry field 1504, into which a user may enter a password to be stored in his or her newly created account record in user table 119, as email address 405. CRE page 1501 further includes a city entry field 1505, into which a user may enter a city to be stored in his or her newly created account record in user table 119, as city 406. CRE page 1501 further includes a neighborhood entry field 1506, into which a user may enter a neighborhood to be stored in his or her newly created account record in user table 119, as neighborhood 407. CRE page 1501 further includes a submit account button 1507—when the user clicks on submit account button 1507, process manager 112 may cause the user's new account data to be stored in the user's new account record in user table 119. After the user clicks on submit account button 1507, process manager 112 may generate a message which asks the user to verify his or her account, and may cause that message to be transmitted to the messaging component at the user's device.

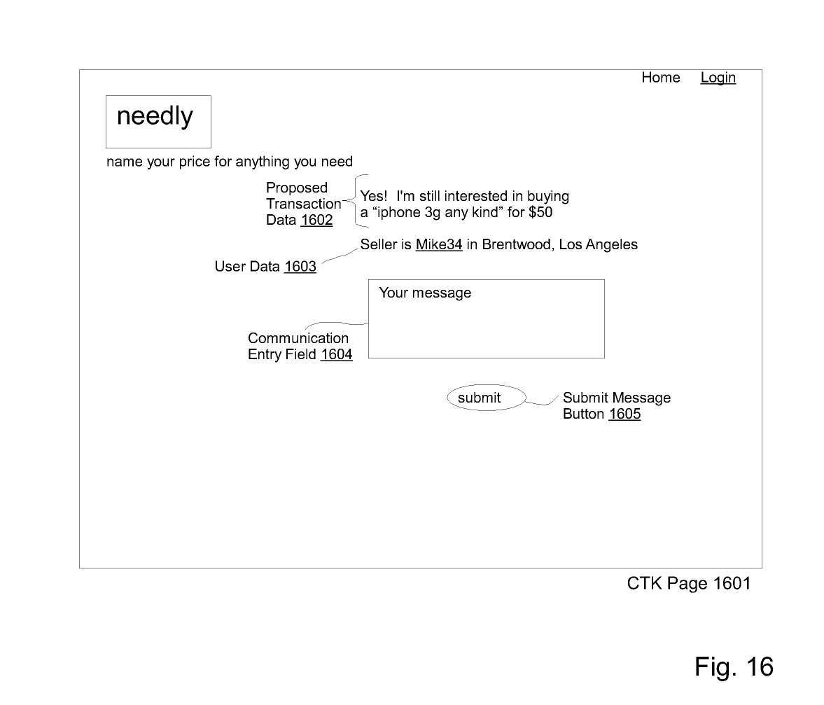

FIG. 16 illustrates one embodiment of contact page (“CTK page”) 1601. CTK page permits a user to send a user communication to another user via a message. “User communication” as used herein means text, video, audio, or other data that a first user transmits to process manager 112 for delivery (i.e., further transmission) to a second user in the form of a message. Alternatively, one or more user communications may be delivered to users via one or more web pages.

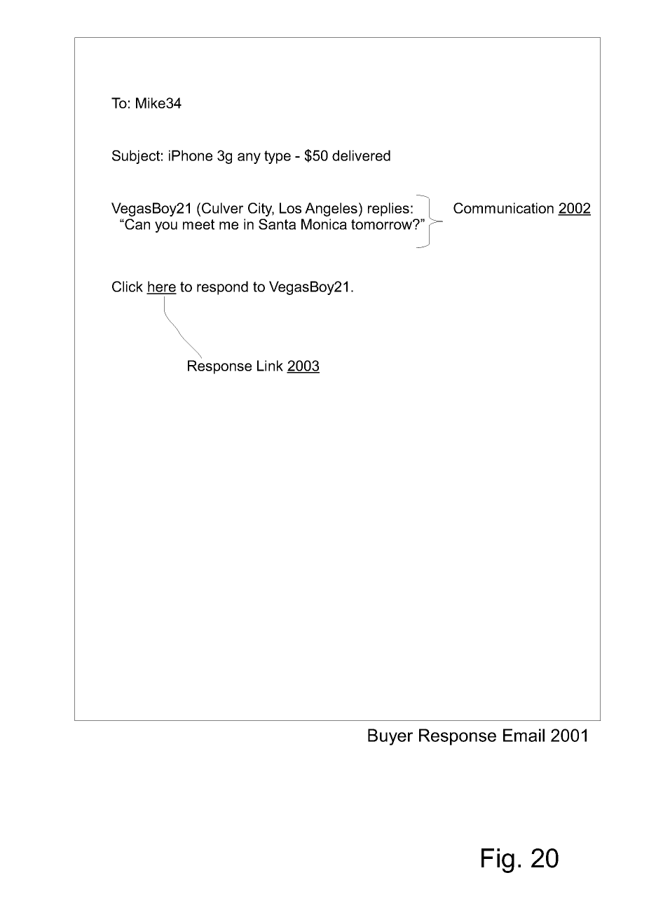

Process manager 112 may cause an embodiment of CTK page 1601 to be displayed at a UI at a user device when the user clicks on a link in a message, as described further below in connection with FIGS. 19 and 20. CTK page 1601, as illustrated, is in the form of a web page addressed to a buyer, which asks the buyer to confirm his or her interest in purchasing an item on which the buyer has previously bid. As illustrated, proposed transaction data 1602 includes the item name 302 and price 506 associated with the bid. CTK page 1601 further includes user data 1603, which provides identifying information about the seller. In this example, user data 1603 includes the seller's username 403, neighborhood 407, and city 406. CTK page 1601 further provides a communication entry field 1604, into which the user may enter text intended for delivery in a message to the other party in a transaction. In this embodiment, process manager 112 then causes the resulting message to be transmitted to the device associated with the seller identified in user data 1603. When the user has entered text into communication entry field 1604, the user may click on submit message button 1605. Consequently (in this example), process manager 112 may generate a message which includes the entered text (and which may take the form of the buyer response email in FIG. 20), and may cause that message to be delivered to messaging component 108 at seller device 103.

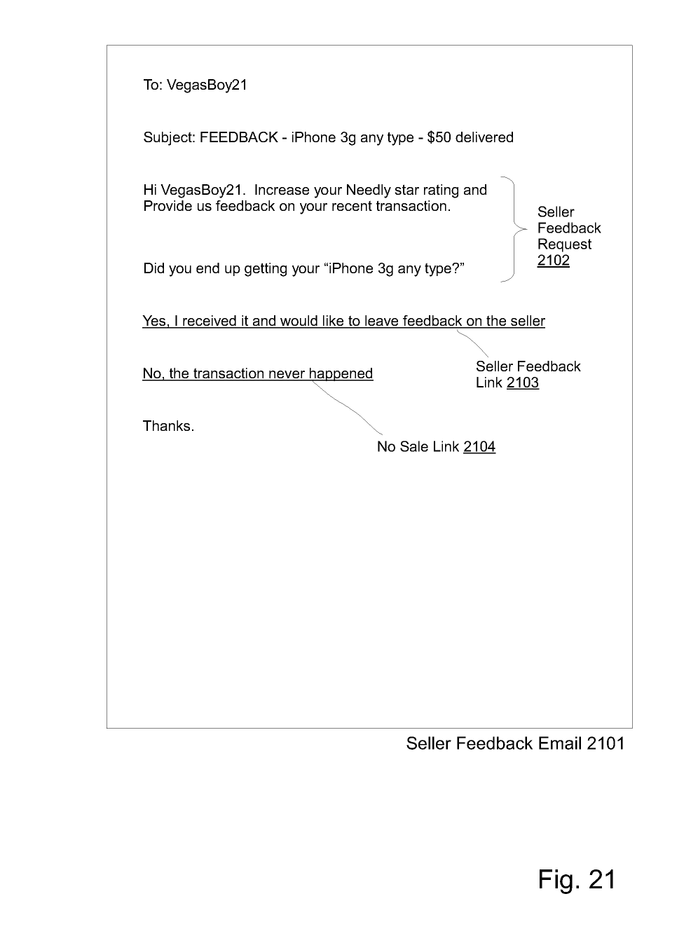

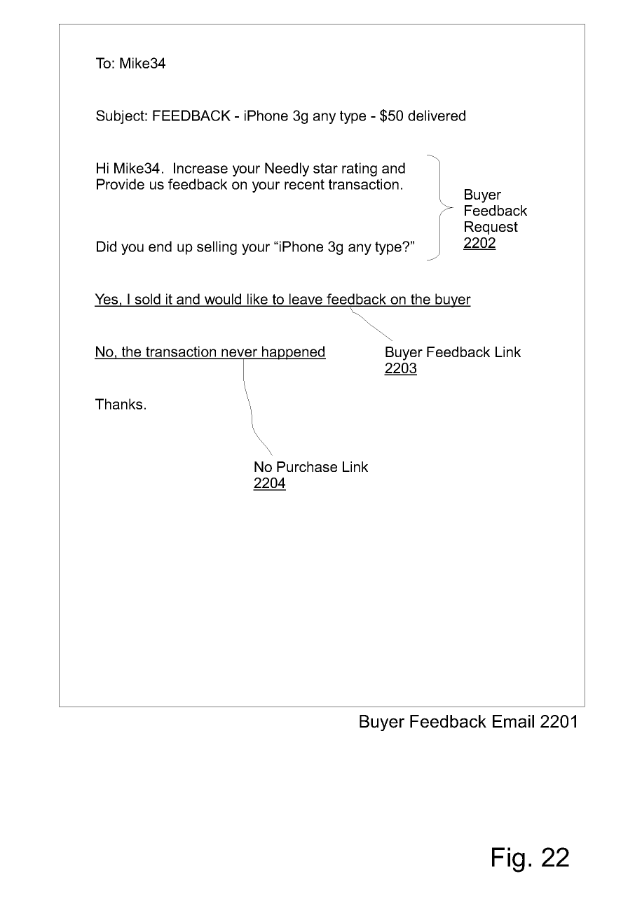

FIG. 17 illustrates one embodiment of feedback page (“FBK page”) 1701. Process manager 112 may cause an embodiment of FBK page 1701 to be displayed at a UI at a user device when the user clicks on a link in a message, as described further below in connection with FIGS. 21 and 22. FBK page 1701 provides an opportunity for a seller to provide feedback on a buyer or, alternatively, for a buyer to leave feedback on a seller. In the embodiment shown in FIG. 17, assuming “VegasBoy22” is the buyer in a transaction, FBK page 1701 asks the seller in that transaction to provide feedback on VegasBoy22. If the seller clicks on positive feedback button 1702, process manager 112 may cause a code to be entered in the BF 509 associated with the relevant transaction record in transaction table 116, which code indicates a positive experience transacting with VegasBoy22. That code may be, for example, a “1” for positive feedback. If the seller clicks on negative feedback button 1703, process manager 112 may cause a code to be entered in the BF 509 associated with the relevant transaction record in transaction table 116, which code indicates a negative experience transacting with VegasBoy22. That code may be, for example, a “2” for negative feedback. The default code for each transaction record in transaction table 116 may be a “0” for “no feedback, and in a preferred embodiment that code will remain unchanged with respect to any given transaction (including without limitation the transaction with VegasBoy22 referred to in FIG. 17) unless the relevant user (in this case, the seller of an item to VegasBoy22) clicks on either positive feedback button 1702 or negative feedback button 1703. It is contemplated that user feedback may be required in connection with the present inventive method, system, and product, and that one or more users who fail to provide feedback after they have completed one or more transactions may be penalized. The penalty may be termination of the violating user's permission to use the present inventive system, method, and product to engage in transactions, or may take any other conceivable form which is permitted under applicable laws.

FBK page 1701 further provides comment entry field 1704, which permits a user to provide a comment with respect to the other party to a transaction. The comments associated with a given user may be stored in that user's account record within user table 119, or alternatively may be stored at data store 115 in any other conceivable manner. When the user who enters a comment into comment entry field 1704 clicks on submit feedback button 1705, process manager 112 may cause the comment to be stored at data store 115.

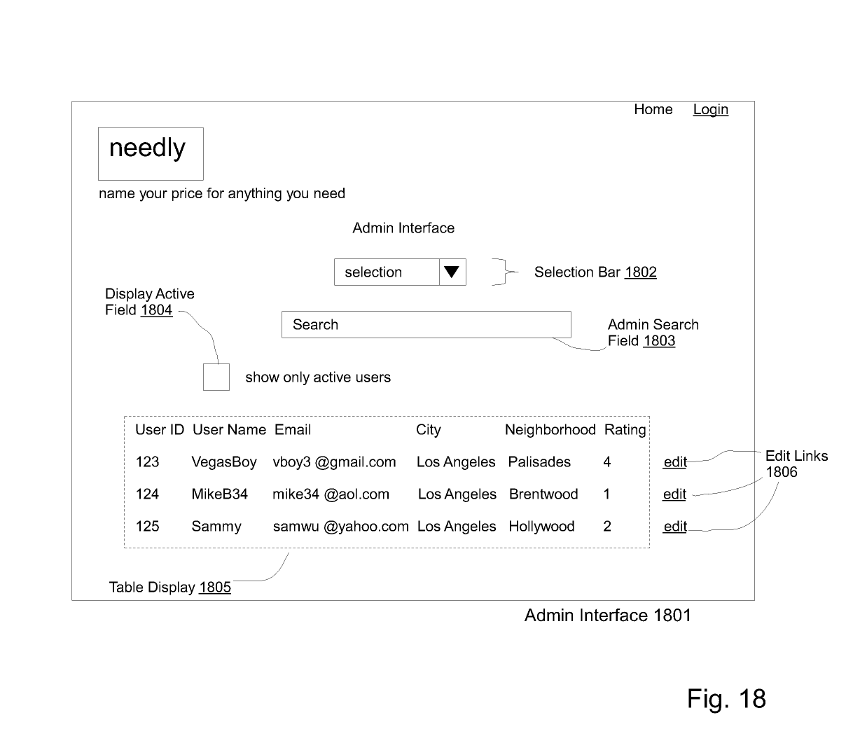

FIG. 18 illustrates one embodiment of administrative interface (“admin interface”) 1801. In this embodiment, an administrator of a transaction service provider (which transaction service provider is offering the present inventive method, system, and product) may access data tables at data store 115 via an admin device 104, and may edit any data within the data tables and/or other components at server 101. The administrator may perform a login operation with the admin device 104 via process manager 112, thereby indicating the administrator has permission to make any desired changes. Alternatively, the administrator may obtain the necessary access to server 101 via any other conceivable means.

As illustrated, admin interface 1801 provides selection bar 1802, which is a drop-down menu that allows the administrator to choose a data table which the administrator would like to edit. In the embodiment shown, the administrator has selected user table 119, and the contents of user table 119 therefore appear in table display 1805. The administrator may search for any data within the displayed data table by entering search terms into admin search field 1803. If the administrator clicks on display active field 1804 as illustrated in FIG. 18, table display 1805 will display only the active users within user table 119. Similarly, if the administrator has selected category table 117 for display within table display 1805, clicking on display active field 1804 will display only the active categories, and the same process applies to item table 118 and transaction table 116. In this embodiment, clicking on the edit link 1806 provided next to any given user's account record will allow the administrator to edit any or all of the data within that account record. For example and without limitation, the administrator may revoke a user's permission to engage in transactions in connection with the present inventive method, system, and product by changing the user active status 410 associated with that user to “inactive”, “banned”, “2” (wherein “2” represents “banned”), or the like. Similarly, after choosing a different data table, the administrator may edit the data within any given row of the chosen data table by clicking on the appropriate edit link 1806. It is also contemplated that a link may be provided in connection with each column within the data table displayed within table display 1805, so that an administrator who clicks on the link associated with a particular column may edit the data within that column.

FIGS. 19 through 22 illustrate representative implementations of messages 127 introduced in conjunction with FIG. 1. FIG. 19 illustrates one embodiment of found email 1901. Found email 1901 may be generated and transmitted to messaging component 106 at buyer device 102 after a seller (for example, the seller associated with seller device 103) hits a bid associated with the buyer. In the embodiment shown, subject line 1902 includes the item name 302 and price 506 associated with the bid the seller has hit. User communication 1903, in this embodiment, includes the user communication to the buyer which the seller entered in buyer communication entry field 1204 at CFS page 1201. User feedback 1904 provides the rating 408 associated with the seller's account record. As illustrated, user feedback 1904 further provides the percentage of transactions for which the seller has received positive feedback, in this example one hundred percent (100%).

Found email 1901 further provides a contact link 1905. In this embodiment, contact link 1905 is associated with a hyperlink URL which, when clicked on, results in the transmission of one embodiment of CTK page 1601 to UI 105 associated with buyer device 102. The transmitted embodiment of CTK page 1601 is then displayed at UI 105, and the buyer may contact the seller via that web page.

Found email 1901 further provides different user link 1907. If the buyer clicks on different user link 1907, process manager 112 may cause the relevant transaction to remain open, thereby enabling a different seller to hit the bid. If the buyer clicks on not interested link 1906, process manager 112 may cause the status 502 associated with the transaction to indicate the buyer is no longer interested in purchasing the previously desired item. For example and without limitation, the status 502 associated with the transaction may be changed to “4”, indicating the buyer has abandoned his or her request to purchase the item.

FIG. 20 illustrates one embodiment of buyer response email 2001. Buyer response email 2001 may be generated and transmitted to messaging component 107 at seller device 103 after a buyer causes a message to be transmitted to a seller. As illustrated, buyer response email 2001 includes communication 2002. Communication 2002 may contain identifying data related to the buyer (in this case, the buyer's username 403, city 406, and neighborhood 407), along with the user communication which the buyer entered in communication entry field 1604 at CTK page 1601 after the buyer clicked on contact link 1905 in found email 1901. Buyer response email 2001 further includes response link 2003. In this embodiment, response link 2003 is associated with a hyperlink URL which, when clicked on, results in the transmission of one embodiment of CTK page 1601 to UI 107 associated with seller device 103. The transmitted embodiment of CTK page 1601 is then displayed at UI 107, and the seller may contact the buyer via that web page.

FIG. 21 illustrates one embodiment of seller feedback email 2101. Seller feedback email 2101 may be generated and transmitted to messaging component 106 at buyer device 102 after the buyer has confirmed his or her interest in a purchase by clicking on contact link 1905 in found email 1901. Seller feedback email 2101 may be transmitted to buyer device 102 after a predetermined amount of time has elapsed since the buyer confirmed interest, for example and without limitation one week later. As illustrated, seller feedback email 2101 includes seller feedback request 2102. Seller feedback request 2102 includes the buyer's username 403, as well as the item name 302 associated with the item ID 505 for the relevant transaction record in transaction table 116. Seller feedback request 2102 further includes seller feedback link 2103. In this embodiment, seller feedback link 2103 is associated with a hyperlink URL which, when clicked on, results in the transmission of one embodiment of FBK page 1701 to UI 105 associated with buyer device 102. The transmitted embodiment of FBK page 1701 is then displayed at UI 105, and the buyer may leave feedback on (and/or a comment regarding) the seller via that web page.

FIG. 22 illustrates one embodiment of buyer feedback email 2201. Buyer feedback email 2201 may be generated and transmitted to messaging component 108 at seller device 103 after the buyer has confirmed his or her interest in a purchase by clicking on contact link 1905 in found email 1901. Buyer feedback email 2201 may be transmitted to seller device 103 after a predetermined amount of time has elapsed since the buyer confirmed interest, for example and without limitation one week later. As illustrated, buyer feedback email 2201 includes buyer feedback request 2202. Buyer feedback request 2202 includes the seller's username 403, as well as the item name 302 associated with the item ID 505 for the relevant transaction record in transaction table 116. Buyer feedback request 2202 further includes buyer feedback link 2203. In this embodiment, buyer feedback link 2203 is associated with a hyperlink URL which, when clicked on, results in the transmission of one embodiment of FBK page 1701 to UI 107 associated with seller device 103. The transmitted embodiment of FBK page 1701 is then displayed at UI 103, and the seller may leave feedback on (and/or a comment regarding) the buyer via that web page.

It should be understood that the implementations of messages 127 illustrated in FIGS. 19 through 22 are merely representative, and any other messages 127, or combinations of them, may be used with any combination of the functionalities and/or content described herein. It is also contemplated that in other embodiments, the present system, method, and product may be used to transmit telephone messages, video messages, email messages, and any other form of messages which are capable of being transmitted via an electronic network.

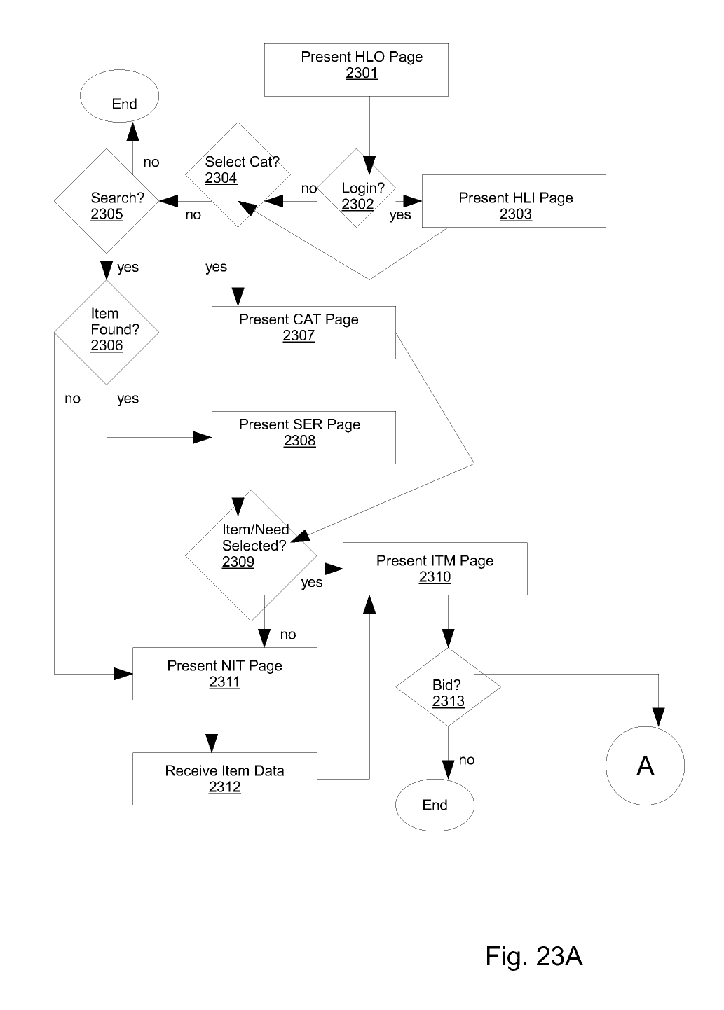

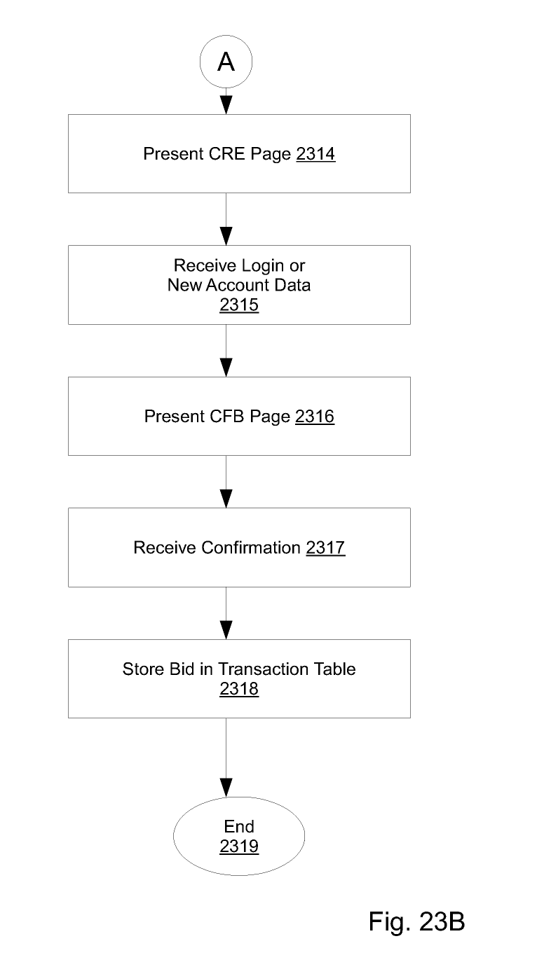

In FIGS. 23A and 23B, by way of an operational flow diagram, there is depicted an embodiment of the present inventive method, product, and system. FIGS. 23A and 23A illustrate one embodiment of the process for a buyer to place a bid for an item. In the embodiment shown, at step 2301, process manager 112 may present HLO page 601 for display on a UI at a user device, for example and without limitation UI 105 at buyer device 102. (“Present for display” refers to all procedures necessary to cause a web page to be displayed on a UI, including without limitation any necessary interactions between process manager 112, web server 12, web page store 124, and/or communications component 128 described herein.) At step 2302, if the user clicks on login link 604 and completes the login procedure, then at step 2303 process manager 112 may present an embodiment of HLI page 701 for display on the UI at the user device, for example and without limitation UI 105 at buyer device 102. After HLI page 2303 is presented, the process proceeds to step 2304. If the user does not complete the login procedure at step 2302, then the process may proceed to step 2304.

At step 2304, if the user clicks on a category link 607, the process may continue to step 2307. At step 2307, process manager 112 may present an embodiment of CAT page 801 for display on the UI at the user device, for example and without limitation UI 105 at buyer device 102. At step 2309, if the user clicks on a category need 804, the process may proceed to step 2310.

At step 2304, if the user does not click on a category link 607, the process may continue to step 2305. At step 2305, if the user performs a search (i.e., the user enters a query into search bar 602 and clicks on go button 603), the process may continue to step 2306. At step 2305, if the user does not perform a search, the process described in FIG. 23A ends. It is to be understood that the process described in FIGS. 23A and 23B relates to the placing of a bid. After the process described in FIG. 23A ends, the user may still use other functionalities of the present inventive method, system, and product, such as (without limitation) clicking on location change link 608.

At step 2306, if database manager 113 communicates one or more item results to process manager 112 in response to the user's query, the process may proceed to step 2308. At step 2308, process manager 112 may present an embodiment of SER page 901 for display on the UI at the user device, for example and without limitation UI 105 at buyer device 102. At step 2309, if the user clicks on an item result 903, thereby transmitting a notification to process manager 112 of the user's interest in purchasing the item associated with the item result, the process may proceed to step 2310.

At step 2306, if database manager 113 communicates zero item results to process manager 112 in response to the user's query, the process may proceed to step 2311. At step 2311, process manager 112 may present an embodiment of NIT page 1401 for display on the UI at the user device, for example and without limitation UI 105 at buyer device 102. In a similar fashion, if at step 2309 the user does not click on a category need 804 or an item result 903, and the user instead clicks on new item page link 805, the process may proceed to step 2311.

At step 2311, the user enters an item name in item entry field 1403, and may select a category via category selection bar 1402. When the user clicks on submit item button 1405, process manager 112 causes a new item record to be created in item table 118, which new item record includes the data associated with the new item (including without limitation the item name 302). The process may them proceed to step 2310.

At step 2310, process manager 112 may present an embodiment of ITM page 1001 for display on the UI at the user device, for example and without limitation UI 105 at buyer device 102. The ITM page 1001 may include a specified item 1002, which specified item 1002 reflects the choice of item (or submission of a new item) the user made at an earlier step. At step 2313, if the user does not submit a bid, the process described in FIG. 23A ends.

At step 2313, if the user submits a bid (by entering a price in bid entry field 1004 and clicking on submit button 1006), the process proceeds to step 2314. (Steps 2314 through 2319 are illustrated in FIG. 23B.)

At step 2314, if the user did not previously login at step 2302, the process continues to step 2314. (Alternatively, if the user did login at step 2302, then steps 2314 and 2315 may be omitted, and the process may proceed to step 2316.) At step 2314, process manager 112 may present an embodiment of CRE page 1501 for display on the UI at the user device, for example and without limitation UI 105 at buyer device 102. Alternatively, process manager 112 may cause a login page to be displayed at the user interface of the user's device, and may require the user to login before the process proceeds to step 2316. Alternatively, process manager 112 may cause a web page to be displayed at the user's device which presents the option to either login or create a new account.

At step 2315, process manager 112 receives new account data from the user and causes a new account record to be created for the user. Alternatively, at step 2315, process manager 112 receives login data for the user. In either event, process manager 112 may cause session manager 131 to initiate an authenticated session for the user. The process may then proceed to step 2316.

At step 2316, process manager 112 may present an embodiment of CFB page 1301 for display on the UI at the user device, for example and without limitation UI 105 at buyer device 102. At step 2317, process manager 112 receives confirmation of the bid when the user clicks on confirm bid field 1305 and further clicks on submit confirmation button 1307. At step 2318, process manager 112 causes the data associated with the bid (including without limitation the price 506 and an item ID 505 related to the user's choice of item (or submission of a new item)) to be stored in a new transaction record in transaction table 116. At step 2319, the process ends.

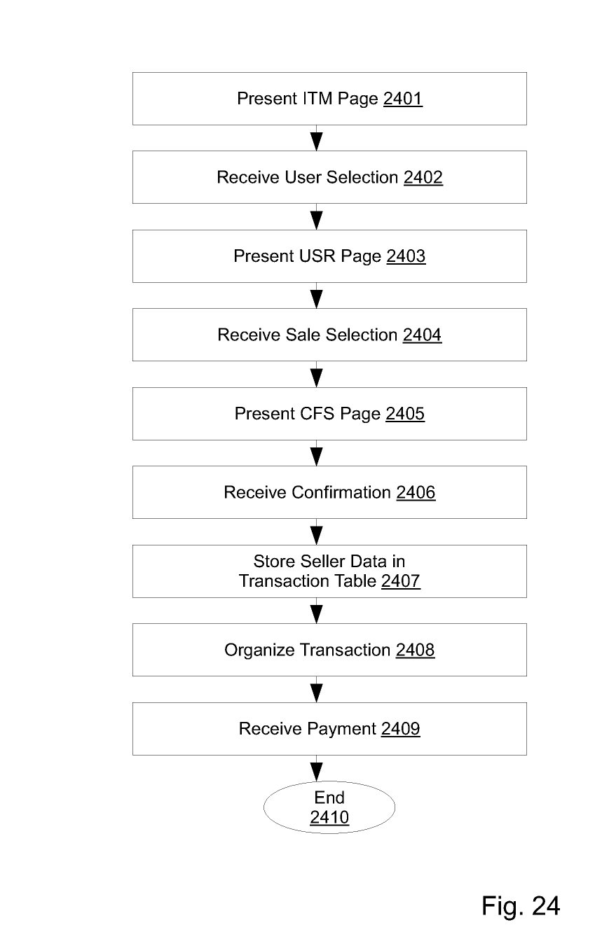

In FIG. 24, by way of an operational flow diagram, there is depicted another embodiment of the present inventive method, product, and system. FIG. 24 illustrates one embodiment of the process for a seller to hit a bid for an item. It is contemplated that prior to step 2401, the seller has caused process manager 112 to initiate an authenticated session (by logging in or creating a new account). It is further contemplated that the seller has searched for an item in a manner consistent with the steps outlined in FIG. 23A. In addition, it is contemplated that the seller has selected either a category need at an embodiment of CAT page 801 or an item result at an embodiment of SER page 901 (see steps 2307 through 2309).

In the embodiment shown, at step 2401, process manager 112 may present an embodiment of ITM page 1001 for display on the UI at the user device, for example and without limitation UI 107 at seller device 103. The ITM page 1001 may include a specified item 1002, which specified item 1002 reflects the choice of item the user made at an earlier step. The ITM page 1001 may further include buyer data 1005, which buyer data 1005 may include one or more links associated with one or more other buyers.

At step 2402, process manager 112 receives the user's selection of an other buyer who is listed within buyer data 1005. Without limitation, process manager 112 may receive this selection when the user clicks on a link associated with an other buyer listed in buyer data 1005. At step 2403, process manager 112 may present an embodiment of USR page 1101 for display on the UI at the user device, for example and without limitation UI 107 at seller device 103. The USR page 1101 may include without limitation data pertaining to the selected buyer, including without limitation the selected buyer's specified user data 1105, the selected buyer's user needs 1102, and other data more fully described herein in connection with FIG. 11.

At step 2404, process manager 112 receives the user's selection of a sale initiation link 1106 on USR page 1101. At step 2405, process manager 112 may present an embodiment of CFS page 1201 for display on the UI at the user device, for example and without limitation UI 107 at seller device 103. At step 2406, process manager 112 receives confirmation of the sale after the user has clicked on acceptance field 1205 and submit acceptance button 1207.

At step 2407, process manager 112 causes the data associated with the sale (including without limitation a seller ID 503) to be stored in the transaction record in transaction table 116, which transaction record is associated with the specified item and the selected buyer. At step 2408, process manager 112 causes the performance of one or more server-side actions (i.e., actions which may be performed by the components at server 101) which are necessary or desirable to organize the transaction, including without limitation the transmission of one or more messages to the buyer and/or the seller.

In the embodiment shown, at step 2409, payment is received from the seller via payment processing component 117. It is contemplated that upon conclusion of a sale (i.e., when the seller has delivered the item and has received the price), the seller may be required to transmit a message to process manager 112 indicating that the sale is complete (such message is referred to herein as a “completion notice”). In one embodiment, the seller may be required to pay a commission to a transaction service provider that is offering the present inventive system, method, and product. Such a commission may be paid via payment processing component 117 by directly initiating an electronic transfer of funds, by authorizing an electronic transfer of funds (which authorization and/or transfer may be made at any point in time), or by any other conceivable means. Alternatively, the commission may be paid to the transaction service provider by check, cash, or any other non-electronic means. It is contemplated that payment may be received from the buyer under any circumstances and using any method described herein, either as an alternative to receiving payment from the seller or in addition to receiving payment from the seller. At step 2410, the process ends.

The facilitation of any transactions which can be conducted through the Internet, or through any other electronic means, is contemplated in conjunction with the present embodiment. Further, it is contemplated that the present invention may be embodied within one or more downloadable applications which may be downloaded to users' mobile devices to facilitate use of the present inventive method, product and system.

As will be appreciated by those persons skilled in the art, the present inventive method, product and system, inclusive of one or more embodiments of its operation through software and hardware systems and the like, affords distinct business advantages not previously available to participants in electronic commercial transactions. For example and without limitation, buyers may benefit from creating open transactions for items they would like to purchase, but would like to acquire at a low cost. Instead of being required to compete with other buyers to pay a relatively high price, the buyers may use the present inventive system, method, and product to increase the likelihood that a seller will contact them and provide them with their desired items at the prices the buyers select. The ratings and comments provided in connection with the present inventive system, method, and product will greatly assist users in determining which other users they would prefer to conduct transactions with. Location-based needs displays will assist sellers in determining which items are most in demand in their vicinities, and may consequently inspire sellers to increase the supply of desired items for one or more particular areas, thereby increasing the frequency with which buyers' needs are met. Location-based search queries will assist many buyers whose desired items match the most frequent queries made by users in their cities and/or neighborhoods.

While this invention has been described in connection with what are currently considered to be the most practical and desirable embodiments, it is to be understood that the invention is not limited to the disclosed embodiments in any way as such are merely set forth for illustrative purposes. The present inventive product and system and methods are intended to cover an array of various modifications and equivalent arrangements, all of which are contemplated for inclusion within the scope and spirit of the disclosure and appended claims.

What is claimed is:

1. A computer-implemented method for the facilitation of a transaction between a buyer and a seller, the method comprising, in no particular order, the steps of:
receiving a first set of new account data from the buyer, the first set of new account data including a first username and a first email address;
storing the first set of new account data in a user table at a data store;
receiving a query from the buyer, the query corresponding to an item;
searching an item table for a first search result, the first search result corresponding to the item;
presenting the first search result via a user interface at a buyer device;
receiving a bid from the buyer, the bid including an item name for an item, the item name corresponding to an item identifier, the bid further including a price the buyer wishes to pay for the item;
storing, in a transaction table at the data store, a transaction record including at least the item identifier, the price, and a buyer identifier corresponding to the buyer;
receiving a second set of new account data from the seller, the second set of new account data including a second username and a second email address;
storing the second set of new account data in the user table at the data store;
receiving an other query from the seller, the other query corresponding to the item;
searching the item table for a second search result, the second search result corresponding to the item;
presenting, via an other user interface at a seller device, the second search result and one or more links, each link corresponding to its own particular buyer;
receiving a first notice indicating that the seller wishes to sell the item to the buyer in exchange for the price;
storing, in the transaction record, a seller identifier corresponding to the seller; and
transmitting a message to the buyer, the message including a user communication from the seller.

2. The method of claim 1, further comprising receiving a payment in exchange for the service of facilitating the transaction between the buyer and the seller.

3. The method of claim 2, wherein the payment is received from the seller.

4. The method of claim 2, wherein the payment is received from the buyer.

5. The method of claim 1, further comprising collecting the price from the buyer in advance of the transaction, receiving a second notice indicating that the transaction is complete, and transferring the price into a financial account related to the seller.

6. The method of claim 1, further comprising receiving from the seller a numerical score the seller has given to the buyer with respect to the transaction between the buyer and the seller, receiving a comment from the seller regarding the buyer with respect to the transaction, and displaying the comment in connection with a user page related to the buyer.

7. The method of claim 1, wherein the message further includes a rating for the seller, the rating being the total number of instances on which the seller has received positive feedback from other buyers.

8. The method of claim 1, wherein the first set of new account data further includes a city, further comprising displaying a list of other items, each of the other items being desired by an other buyer located in the city.

9. The method of claim 1, wherein the first query is selected from one or more predefined queries.

10. The method of claim 9, wherein the one or more predefined queries correspond to the most frequently used queries in a city.

11. The method of claim 1, wherein the buyer selects the item from one or more search results in connection with the bid, each of the one or more search results being produced from the item table in response to a selection from a list of category links, each of the category links being related to a category of one or more items.

12. A computer-readable medium having computer-executable instructions for performing the method of claim 1.

13. A computer-implemented method for the facilitation of a transaction between a buyer and a seller, the method comprising, in no particular order, the steps of:
presenting a first web page for display on a user interface at a buyer device, the first web page permitting the entry of a buyer username and a buyer password;
receiving the buyer username and the buyer password, the buyer username and the buyer password corresponding to a first user identifier;
presenting a second web page for display on the user interface, the second web page including a first search bar;
receiving a query via the first search bar, the query corresponding to an item;
searching an item table for a first search result corresponding to the item;
presenting a third web page for display on the user interface, the third web page including the first search result, the first search result corresponding to an item identifier;
receiving a notification of interest in purchasing the item associated with the first search result;
presenting a fourth web page for display on the user interface, the fourth web page including a bid entry field and a submit button, the submit button permitting the transmission of a price after the price is entered in the bid entry field;
receiving the price;
presenting a fifth web page for display on the user interface, the fifth web page including a submit confirmation button, the submit confirmation button permitting a confirmation of interest in purchasing the item;
receiving the confirmation of interest in purchasing the item; and
storing the item identifier, the price, and a buyer identifier in a transaction record at a transaction table, the buyer identifier corresponding to the first user identifier.

14. The method of claim 13, further comprising, in no particular order, the steps of:
presenting a sixth web page for display on an other user interface at a seller device, the sixth web page permitting the entry of a seller username and a seller password;
receiving the seller username and the seller password, the seller username and the seller password corresponding to a second user identifier;
presenting a seventh web page for display on the other user interface, the seventh web page including a second search bar;
receiving an other query via the second search bar, the other query corresponding to the item;
searching the item table for a second search result corresponding to the item;
presenting an eighth web page for display on the other user interface, the eighth web page including the second search result, the eighth web page further including one or more links to one or more user pages, each of the one or more user pages corresponding to a particular user;
receiving a selection of one of the one or more links, the selected link corresponding to the buyer;
presenting a ninth web page for display on the other user interface, the ninth web page including a list of one or more item names, each of the one or more item names corresponding to a particular item desired by the buyer, each of the one or more item names further being associated with its own respective sale initiation link;
receiving a selection of one of the sale initiation links, the selected sale initiation link being associated with the item;
presenting a tenth web page for display on the other user interface, the tenth web page including a submit acceptance button, the submit acceptance button permitting a confirmation of interest in selling the item;
receiving the confirmation of interest in selling the item;
storing a seller identifier in the transaction record at the transaction table, the seller identifier corresponding to the second user identifier; and
transmitting a first message to a first messaging component at the buyer device, the first message relating to the transaction.

15. The method of claim 14, further comprising, in no particular order, the steps of:
transmitting a second message to a second messaging component at the seller device, the second message relating to the transaction, the second message further being initiated at the buyer device; and
receiving payment at a payment processing component, the payment being for the service of arranging the transaction.
